(19) United States
(12) Patent Application Publication
(10) Pub. No.: US 2019/0354982 A1
(43) Pub. Date: Nov. 21, 2019

(54) WIRE TRANSFER SERVICE RISK DETECTION PLATFORM AND METHOD

(71) Applicant: Sigue Corporation, Sylmar, CA (US)

(72) Inventor: Oswaldo Zarate Gómez, Guadalajara (MX)

(21) Appl. No.: 16/046,891

(22) Filed: Jul. 26, 2018

Related U.S. Application Data
(60) Provisional application No. 62/672,448, filed on May 16, 2018.

(51) Int. Cl. G06Q 20/40; G06Q 20/08; G06Q 20/10; G06Q 40/02

(52) U.S. Cl. CPC G06Q 20/4016; G06Q 20/405; G06F 17/18; G06Q 20/102; G06Q 40/02; G06Q 20/085

(57) ABSTRACT

A system and a method for an analysis tool for analyzing a high volume of money transfer transactions to identify suspicious patterns for follow up by a trained human analyst, or user. If a group of transactions meet a specified criteria, an alert is generated, and the system aggregates additional transactional data concerning transactions and individuals that may be linked to the first group of transactions. The matter is then handed off to a trained human analyst to determine whether there is in fact suspicious activity. An agent risk analysis employs statistical analysis by the system to identify agents of a money transfer organization whose activity is determined to be an outlier compared to similarly-situated agents. A human analyst then reviews aggregated data concerning high-risk agents to determine whether and what action should be taken.

### CROSS-REFERENCE TO RELATED APPLICATIONS

This application claims the benefit of U.S. Provisional Application No. 62/672,448, filed May 16, 2018, the entirety of which is hereby incorporated by reference.

### BACKGROUND

The present disclosure pertains to analysis and detection of potential misuse of wire transfers and identification of risks associated with a wire transfer service.

A wire transfer, or a money transfer, is a way to send money from one person to another person somewhere around the world. Generally, the money transfer process includes a sender, also referred to as a remitter, initiating the money transfer through an agent. The agent is usually independent, but associated with a money transfer organization such as Western Union® or Sigue®. The sender gives funds to the agent, which then transfers the funds to the money transfer organization. The money transfer organization in turn transfers the funds to a paying agent, which then delivers it to a recipient, also referred to as a beneficiary.

Millions of money transfer transactions occur every day throughout the world. Many of these money transfer transactions are legitimate, such as a man working in the US sending money to his mother in Mexico. However, the money transfer process can also be used for nefarious purposes, such as by criminals to launder ill-gotten money. Further, the agents typically are independent businesses and the senders are customers of the agents, not directly customers of the money transfer organization. As such, the money transfer organization may have very little information about individual senders. Thus, bad actors can seek to use complex strategies to improperly use the money transfer system, and rely on suspicious, fraudulent, or criminal transactions to be lost among the millions of legitimate transactions.

In many countries, money transfer organizations are obligated to monitor fund transfers in order to identify potential abuses of the money transfer system. However, due to the high volume of transactions, and the fact that the money transfer organizations often have very limited information about remitters and beneficiaries, it can be difficult and time-consuming to identify possible abuses of the system with consistency and reliability.

### SUMMARY

Accordingly, there is a need in the art for an efficient system and method for identifying possible abuses of the money transfer system, and more fully investigating such possible abuses.

The present disclosure relates to an automated analysis tool for reviewing a large volume of transaction data in order to flag suspected criminal money transfers and aggregate relevant data concerning such transfers for follow up and analysis by a trained analyst, or user. Generally, the present disclosure relates to accessing a database and analyzing the data from the database to identify patterns that indicate possible abuses of the money transfer services. When a potentially-troublesome pattern is identified, the software automatically generates alerts, in which it obtains more information about the potentially problematic transactions, as well as the individuals involved with or otherwise linked to the transactions, and automatically generates, or opens, a case file into which the transaction information is placed. A human analyst, or user, trained to identify abusive patterns, then reviews the case file and makes the determination whether more investigation is warranted or not, and the analyst's decision and accompanying comments are documented and saved in the system. In this manner, the automated analysis tool saves time by identifying parties that are most likely to be abusing the money transfer services and aggregating data that allows a human analyst to determine whether a group of transactions appear suspicious.

The present disclosure also relates to an automated analysis tool that accesses large volumes of transaction data—specifically, transaction data from millions of money transfer transactions—to evaluate the relative risk that each agent poses in connection with misuse of the money transfer system. Preferably, such a tool uses statistical analysis of several weighted risk parameters to compare the business of similarly-situated agents. Agents that are statistical outliers relative to other agents can be identified as being at high risk, while other agents can be classified as medium or low risk depending on the analysis. High risk agents are then subjected to a second level of analysis, in which more detailed statistical information is provided by the system to be considered by a human analyst, who can make a determination whether further analysis is indicated, such as a third level of analysis in which still further information is considered. Such agent reviews may lead to some high risk agents being subjected to mandatory retraining and/or dismissal of their agency.

In accordance with some embodiments, a method is provided for performing agent risk analysis for a money transfer organization in which a plurality of agents facilitate a high volume of money transfers from remitters to beneficiaries. The method comprises processing a high volume of money transfers in which each of the plurality of agents interacts with a plurality of remitters and/or a plurality of beneficiaries, storing data concerning each of the money transfers in a transactions database, and performing an outlier agent identification analysis. The outlier agent identification analysis comprises aggregating data from the transactions database and using the aggregated data to calculate a plurality of primary risk parameters for a selected analysis time period for each of the plurality of agents, applying a grouping criteria to each of the plurality of agents and, based on the grouping criteria, identifying a first group of agents and a second group of agents, generating a primary risk statistical distribution for each primary risk parameter within each group, and identifying the disposition of each primary risk parameter of each agent within the primary risk statistical distribution. In view of the primary risk statistical distribution, a primary parameter risk score is assigned to each primary risk parameter of each agent. The primary parameter risk score is based on the extent to which the particular primary risk parameter is a statistical outlier relative to like primary risk parameters of other agents within the same group. The primary parameter risk scores are aggregated for each agent to define an agent risk score for each agent. An agent risk score statistical distribution of agent risk scores within the same group is generated, and the disposition of the agent risk score of each agent within the agent risk score statistical distribution is identified. In view of the agent risk score statistical distribution, outlier agent risk scores are identified as agent risk scores that meet or exceed a threshold outlier status relative to other agent risk scores in the agent risk score statistical distribution. Each agent having an outlier agent risk score is identified as an outlier agent and an agent alert is generated for each outlier agent. A report aggregating data from the transaction database concerning the outlier agent is generated in each agent alert. A human analyst reviews the agent alert and records observations about the outlier agent. Data concerning each agent alert and analyst observations is saved

Some embodiments additionally comprise a user accessing an agent analysis interface to define criteria for the outlier agent identification analysis. In some such embodiments, each primary risk parameter that lies at or more than a first primary threshold number of standard deviations from the mean of the primary risk statistical distribution is assigned a first risk score. In additional embodiments, each primary risk parameter that lies at or more than a second primary threshold number but less than the first primary number of standard deviations from the mean of the primary risk statistical distribution is assigned a second risk score. In further embodiments, each primary risk parameter that lies less than the second primary threshold number of standard deviations from the mean of the primary risk statistical distribution is assigned a third risk score.

Further embodiments additionally comprise the user setting the first primary threshold number for a first one of the primary risk parameters via the agent analysis interface. In some such embodiments, the first primary threshold number is set so that about 5% of the first ones of the primary risk parameters within an agent group are assigned the first risk score.

In additional embodiments, a weighting criteria is applied to each of the plurality of primary risk parameters, and aggregating the primary parameter risk scores for each agent to define the agent risk score considers the weighting criteria. Some such embodiments additionally comprise assigning a weight to each of the plurality of primary risk parameters via the agent risk analysis interface.

Further embodiments additionally comprise aggregating data from the transactions database for the selected analysis time period to determine a secondary risk parameter result for each agent. Some such embodiments additionally comprise for each agent comparing the secondary risk parameter result to a criteria saved on a system to determine whether the secondary risk parameter meets a risk criteria, and modifying the agent risk score if the secondary risk parameter meets the risk criteria. Further embodiments may additionally comprise calculating a second parameter calculation value using data from the transactions database independently from the outlier agent identification analysis and maintaining the second parameter calculation value on the system, and wherein calculating a second one of the plurality of primary risk parameters comprises retrieving the second parameter calculation.

In further embodiments, the grouping criteria considers each agent's geographic location, and agents located within a first geographic region are in the first group and agents located within a second geographic region are in the second group.

In accordance with another embodiment, a method for mitigating risks associated with agents of a money transfer organization in which a plurality of agents facilitate a high volume of money transfers from remitters to beneficiaries is provided. The method comprises processing a high volume of money transfers in which each of the plurality of agents interacts with a plurality of remitters and/or a plurality of beneficiaries, storing data concerning each of the money transfers in a transactions database, and performing an outlier agent identification analysis. The outlier agent identification analysis comprises aggregating data from the transactions database concerning a plurality of primary risk parameters for a selected analysis time period for each of the plurality of agents, generating a primary risk statistical distribution for each primary risk parameter, and assigning an agent risk score to each of the plurality of agents in consideration of the primary risk statistical distribution. The agent risk score may be based on the extent to which the plurality of primary risk parameters for one of the plurality of agents are outliers relative to plurality of primary risk parameters of the rest of the plurality of agents. An agent risk score statistical distribution of the agent risk scores of the plurality of agents is generated, and outlier agent risk scores are identified as agent risk scores that meet or exceed a threshold outlier status relative to other agent risk scores in the agent risk score statistical distribution. Each of the plurality of agents that has an outlier agent risk score is identified as an outlier agent and an agent alert is generated for each outlier agent. A report is generated aggregating data from the transaction database concerning the outlier agent in each agent alert. A human analyst reviews the report associated with the agent alert and records observations about the outlier agent. Data concerning each agent alert and analyst observations is saved. Action is taken concerning each outlier agent based on the analyst observations.

In additional embodiments, taking action concerning a first one of the outlier agents comprises one or more of terminating the agent alert associated with the first one of the outlier agents, mandating a training regimen for the first one of the outlier agents, suspending the first one of the outlier agents, and terminating associating with the first one of the outlier agents, and saving a record of the action taken in the system.

In accordance with another embodiment, a method for identifying suspicious use of a money transfer system is provided. The method comprises processing a high volume of money transfer transactions, which comprises a remitter providing an amount of money, remitter data and beneficiary data to an agent, the agent accessing a money transfer system from a remote agent system to enter the remitter data, beneficiary data, and an amount of the money transfer, and the money transfer system transferring the amount of money to the beneficiary. The method further comprises storing transaction data concerning each of the money transfer transactions in a transactions database, the transaction data comprising the amount of money, date, remitter data, beneficiary data and an agent data, storing a plurality of business rules on an analysis system, each of the business rules defining criteria for triggering an alert, and analyzing the data from the transactions database for each of the plurality of business rules. If the data associated with one or more origin transactions collectively meets the criteria for a first one of the business rules, an alert is generated and the alert is saved on the analysis system. For each alert, data from the transactions database is searched to identify secondary transactions that share one or more data points with the one or more origin transactions. A report is generated for each alert identifying and presenting the origin transactions, the secondary transactions, and an identification of criteria matching secondary transactions to origin transactions. A human analyst accesses and reviews the report for each alert and records observations about the alert. Data concerning each alert and analyst observations is saved.

In additional embodiments, each money transfer transaction additionally comprises a real time financial screening, comprising accessing data from a database of the money transfer system and comparing one or more of the remitter data and beneficiary data, wherein the money transfer transaction may proceed only if the one or more of the remitter data and beneficiary data manages the data from the database.

In further embodiments, each money transfer transaction additionally comprises a real time financial screening, comprising accessing transactions data concerning the remitter and/or beneficiary from the transactions database and accessing a screening criteria from a database of the money transfer system, aggregating amount data from the transactions data with the amount entered by the agent, and if the aggregated amount data exceeds the screening criteria generating a communication to the remote agent system. In some such embodiments, the communication comprises one or more of a disapproval of the transaction or a request for more detailed identification information concerning one or more of the remitter and beneficiary.

### BRIEF DESCRIPTION OF THE DRAWINGS

FIG. 1 is a flow chart depicting wire transfer transaction flow in accordance with one embodiment.

FIG. 2 is a chart depicting systems for conducting wire transfer transactions and risk analysis in accordance with an embodiment.

FIG. 3 is a flow chart depicting an embodiment of real time financial screening that can be employed in connection with money transfer transactions.

FIG. 4 is a flow chart depicting an embodiment of consumer-side risk identification analysis.

FIG. 5 shows an exemplary general information screen for business rules configurations.

FIG. 6 shows exemplary subscreens in connection with business rule configuration.

FIG. 7 shows an exemplary embodiment of a country selection screen.

FIGS. 8A & B together show an exemplary embodiment of a screen depicting information concerning an alert.

FIGS. 9 A & B together show an exemplary embodiment of a subscreen depicting additional transactions aggregated in connection with an analysis report.

FIG. 10 shows an exemplary screen shot of a textual narrative screen of a suspicious action report (SAR).

FIG. 11 is a flow chart depicting an embodiment of a process for identifying outlier, high-risk agents for further review.

FIG. 12 is a flow chart depicting an embodiment of a process of employing statistical analysis for identifying agents meriting further review.

FIGS. 13A & B together show an exemplary embodiment of a screen for configuring an agent risk assessment.

FIGS. 14A & B together show an exemplary embodiment of an agent risk assessment alerts results screen.

FIG. 15 shows an exemplary embodiment of an agent alerts management screen.

FIG. 16 shows exemplary embodiments of an agent transactional behavior report screen.

FIG. 17 shows an exemplary embodiment of charts visually showing statistical information regarding transactions by an agent, which charts can be presented in conjunction with a report.

FIG. 18 shows an exemplary embodiment of a screen listing remitters that have conducted money transfer transactions with the agent, which listing can be presented in conjunction with a report.

FIG. 19 shows an exemplary embodiment of a screen listing beneficiaries that have received money due to money transfer transactions with the agent, which listing can be presented in conjunction with a report.

FIG. 20 shows an exemplary embodiment of a screen listing high velocity behavior of an agent, which listing can be presented in conjunction with a report.

### DESCRIPTION

The description set forth below in connection with the appended drawings is intended as a description of presently preferred embodiments of the wire transfer operator risk analysis platform and methods provided in accordance with aspects of the present components, assemblies, and methods, and is not intended to represent the only forms in which the present components, assemblies, and methods may be constructed or utilized. The description sets forth the features and the steps for constructing and using the embodiments of the present components, assemblies, and methods in connection with the illustrated embodiments. It is to be understood, however, that the same or equivalent functions and structures may be accomplished by different embodiments that are also intended to be encompassed within the spirit and scope of the present disclosure. As denoted elsewhere herein, like element numbers are intended to indicate like or similar elements or features.

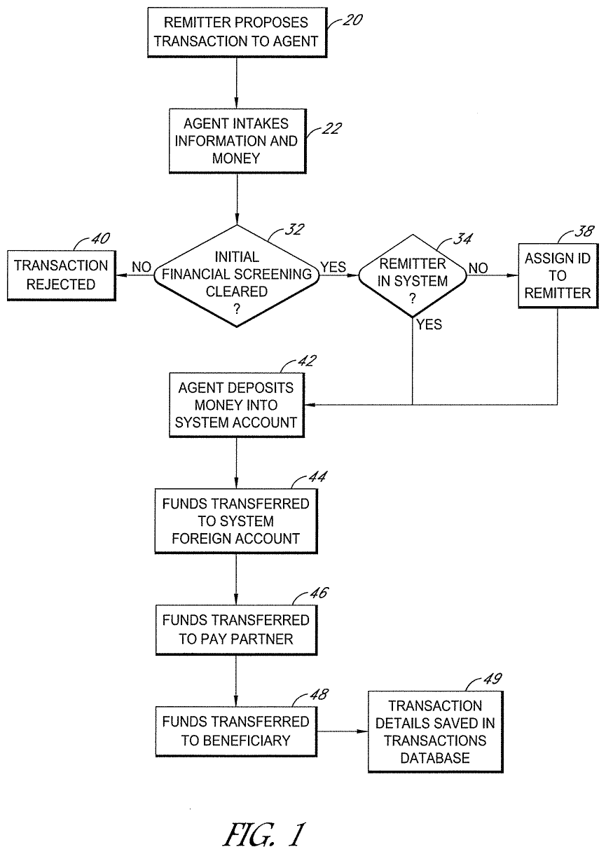

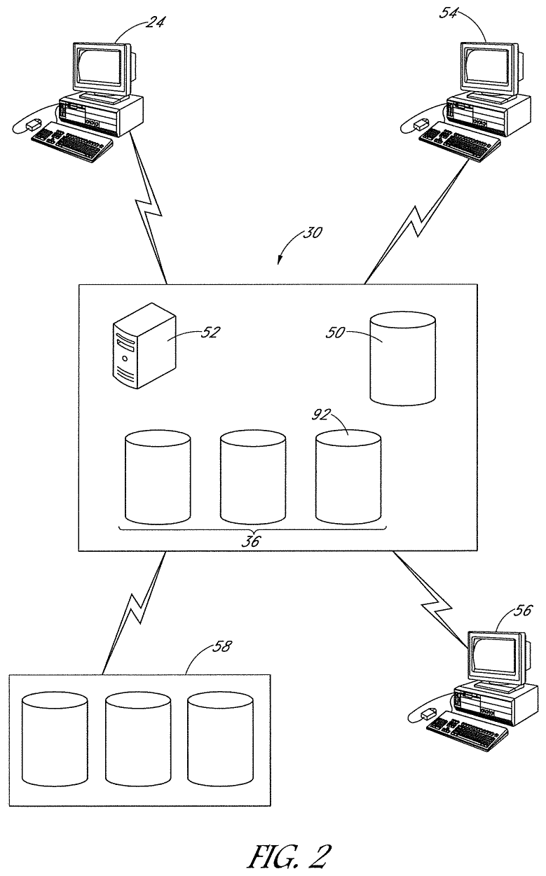

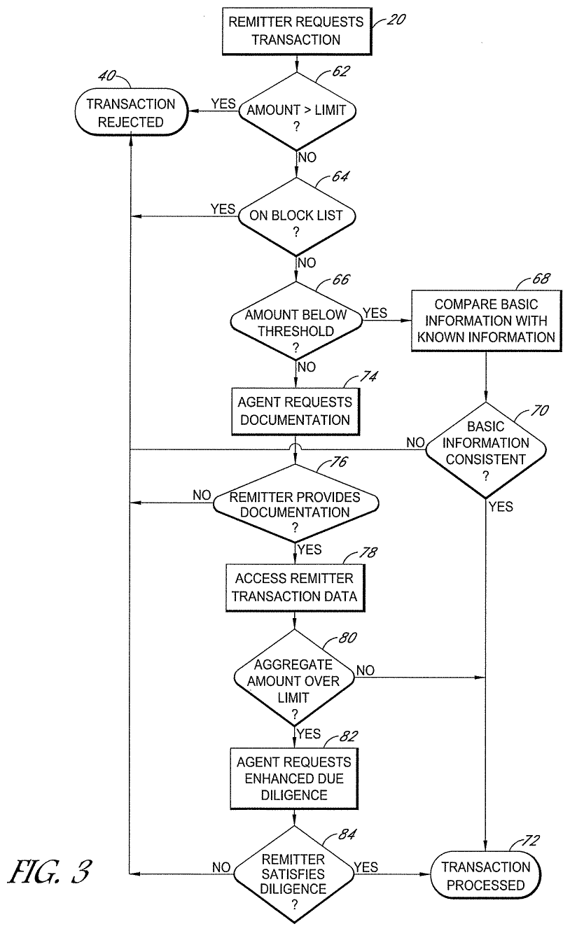

With initial reference to FIGS. 1 and 2, in accordance with one embodiment, a wire transfer (i.e. money transfer transactions) can be initiated when a remitter approaches an agent to request 20 a money transfer. Typically, the agent is an independent individual or business that is associated with a particular money transfer organization, and has access to the money transfer organization's system. At step 22 the agent intakes basic information about the remitter, such as name, address and phone number, as well as the amount of the proposed transfer. The agent enters this information into its own system—a remote agent system 24—which communicates the information to the money transfer organization's system 30.

After initial intake concerning basic information about the remitter and transfer amount for a proposed transaction is performed, the money transfer organization system 30 performs an initial financial screening 32 of the proposed transaction. Such initial financial screening is performed in real time and can include data comparisons and one or several evaluations of criteria, as will be discussed in more detail below. If the proposed transaction fails initial financial screening, the proposed transaction is rejected 40. If the proposed transaction clears initial financial screening, the system accesses 34 an internal system database 36 to determine whether a profile of the remitter is saved within the system (and associated with a unique remitter ID). If the remitter is not found, the remitter is assigned 38 a unique remitter ID, and the remitter's basic identification information and associated remitter ID is saved in the system 30, such as within one of the system's internal databases 36.

As part of the transaction, the agent receives funds from the remitter. The agent next deposits such funds to be transferred into the money transfer system's bank account 42. If necessary, such as if the beneficiary is in a different country, the system will transfer 44 the funds to another system bank account in the beneficiary's country. From that bank account, the funds preferably are transferred 46 to a pay partner, who in turn transfers 48 the funds to the beneficiary. Notably, details concerning the transaction, such as date, time, amount transferred, name and location of the agent, remitter, beneficiary, pay partner, and the like are saved 49 in a transactions database 50 associated with, or part of, the system 30. It should be appreciated that a high volume of such money transfer transactions—such as on the order of several million transactions per week—can be performed by a single money transfer organization. This high volume of transactions can make it difficult to identify and track patterns indicative of criminal activity.

It is to be appreciated that the money transfer organization system 30 can be configured in several ways. With continued reference to FIG. 2, preferably the money transfer organization system 30 includes a computer system comprising a server(s) 52 having processor(s) and data storage structures such as databases, as well as structures for interfacing with humans as well as other computer systems and equipment. For example, the system can interface with multiple organization systems 54 such as user and manager systems, which can include workstations, from which users can access databases, make changes to analyses and procedures, perform maintenance and make adjustments to the system, as well as compliance systems, from which financial analysts may obtain information about possible misuses of the money transfer system. External systems with which the money transfer organization system 30 may interface include several remote agent systems 24, as well as several external databases 58, which can include databases maintained by governments/law enforcement and commercial entities. Interfaces with internal and external systems can be facilitated by any of several types of computer interface structures 60, including the internet, wired and/or wireless network access connections, Wi-Fi, Bluetooth, or the like.

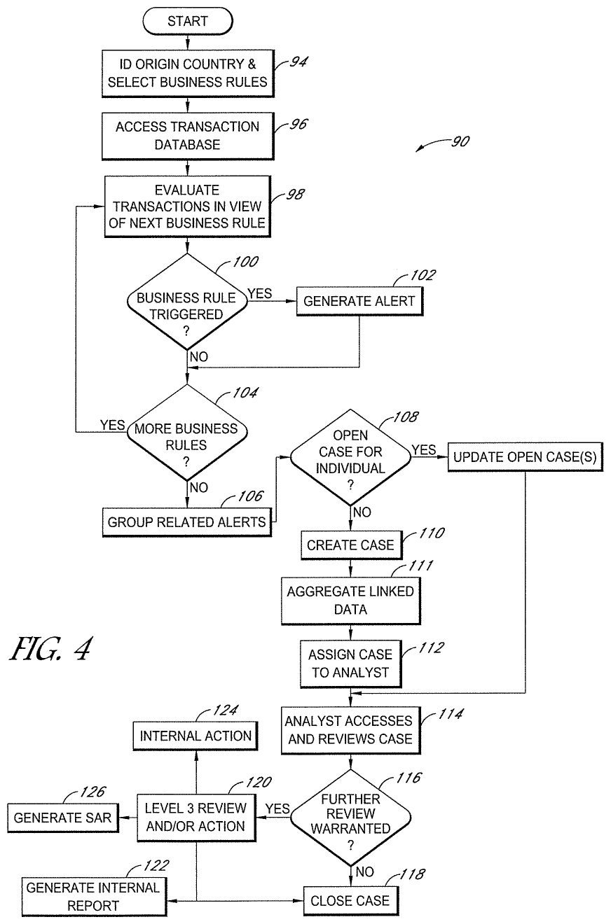

As discussed above, prior to accepting and performing a proposed transaction, the system 30 preferably performs an initial financial screening 33 of the proposed transaction. Depending on local law and other factors, the specifics of such initial financial screenings can vary. FIG. 3 presents a flow chart of one embodiment of an initial financial screening 32. It is to be understood, however, that in other embodiments an initial financial screening can be configured somewhat differently.

With reference to FIG. 3, an initial consideration is whether the amount of the proposed transaction exceeds legal limits or the system's own policy limits to, and rejecting 40 the proposed transaction if the limit is exceeded. For example, if the agent is located in Great Britain and the amount of the proposed transaction exceeds 6,000 GBP, the proposed transaction will be rejected, as Great Britain law limits money transfers to amounts less than 6,000 GBP. If the proposed transaction amount is below legal and policy limits, the system 30 will check whether the remitter (and/or, in some embodiments, the beneficiary) is on any block lists before. This may involve reviewing one or more databases, such as an internal system database 36 of blocked remitters, or an external, government-operated database 58 of blocked money-transfer remitters or beneficiaries. If the proposed remitter or beneficiary is on such a block list, the proposed transaction will be rejected 40.

In many localities, if a money-transfer transaction is below a threshold amount, the transaction may proceed with little or no need for the remitter to prove his or her identity. In a preferred embodiment, the system still performs some initial analysis in such situations to verify information provided by the remitter and identify risky transactions. Thus, if the system determines that the proposed transaction amount is less than the threshold amount the six, the system will then compare the eight basic information provided by the remitter against information existing in its own internal databases 36 and/or external databases 58 to which it has access. The system then determines 70 whether information provided by the remitter is consistent with available information from the databases. If, based on this initial review, it appears that the basic information provided by the remitter is correct, the transaction will be processed 72. However, if it appears that the basic information provided by the remitter is inconsistent with available information from the databases, indicating it is false or incorrect, the transaction will be rejected 40. As an example, in one embodiment the remitter provides his name, address and phone number. As part of the initial analysis, the system accesses an external telephone number database and discovers that the telephone number is associated with a different name. The system also accesses an external address database and also discovers that the address does not exist. The system thus determines that there is a high risk that the basic information is incorrect or fraudulent. Of course, it is to be understood that additional criteria can also be employed. For example, in another embodiment, the system accesses its internal transactional database and learns that the address provided by the remitter has, within the previous 6 months, been used by 5 other remitters, or similarly that the address provided for the beneficiary has, within the previous 3, 9 or 12 months, been used with 2, 3, 5 or some other trigger number of beneficiaries. It is to be understood that various criteria indicating inconsistency or high risk of misuse can be used in such initial analyses. Such criteria for determining high risk of misuse preferably is saved in one or more internal databases 36.

In some embodiments, in order to avoid problems arising from minor typographical errors and/or in order to more thoroughly perform an initial analysis (or a more detailed analysis as discussed in further embodiments in this disclosure), user information can be analyzed using a phonetic coding system intended to suppress spelling variations, such as a Soundex system. In this specification, when reference is made to reviewing information, it is contemplated that such review may incorporate applying such a phonetic coding system to various data entries such as names and addresses.

In additional embodiments, if the system determines that the basic information is incorrect or indicative of high risk, rather than automatically rejecting the transaction the system may generate a notice to the agent, and give the remitter the opportunity to correct, explain, or verify (such as by presenting a state-issued identification card) the basic information. The agent may re-submit the proposed transaction for initial screening after corrections are made or basic information is verified.

With continued reference to FIG. 3, if at step 66 the proposed transaction is for an amount above the threshold value, but below the policy limit, the agent will be requested to verify 74 certain of the basic information provided by the remitter. This is sometimes referred to as enhanced due diligence. In some embodiments, this can be achieved by the remitter submitting a state-issued identification verifying information such as the remitter's name and address. In some embodiments other documents, such as utility bills, can be used to verify a remitter's name and address. If the remitter is unwilling to provide verification 76, the proposed transaction may be rejected 40, and in some embodiments a notice may be generated and sent to a Compliance department of the money transfer organization. Additionally, a record of the rejected transaction, including reasons therefor, can be saved in the transactions database 50 or another database 36.

There may be additional policy or local legal requirements that may need to be satisfied before a proposed transaction is processed. For example, in one embodiment, the money transfer organization requires enhanced due diligence if a remitter's aggregate amount of money transferred exceeds a threshold amount over a particular time period (such as, for example, 10,000 GBP over a 90-day period). Of course, this aggregate amount depends on data stored in the transactions database 50 and is not available to the agent. Thus, if a remitter satisfies the initial analysis and/or provides sufficient verification of basic information, the system then accesses data from the transactions database to determine the aggregate amount of money transferred 80 for the remitter over the selected time period. If the aggregate amount does not exceed the limiting amount, the proposed transaction will proceed, but if it exceeds the limiting amount, the agent will be prompted to request enhanced due diligence 82. Enhanced due diligence preferably is directed to obtaining more detail about the remitter and the funds to be transferred in order to ensure that the proposed transaction is for legitimate purposes that do not misuse the money transfer system. If the remitter cooperates with, and satisfies 84, such enhanced due diligence requirements, the proposed transaction will proceed 32, otherwise the proposed transaction may be cancelled/rejected 40.

In some embodiments, enhanced due diligence may include one or more of, for example, enhanced requirements for identification verification, evidence concerning the source of the funds to be transferred, identification of the relationship between the remitter and the beneficiary, and the like. Also, in additional embodiments, the requirement for enhanced due diligence may be triggered by factors other than the aggregate amount of money transferred. Other factors can include, for example, the aggregate number of separate transactions over the past ninety days (or another period).

It is to be understood that, in additional embodiments, all proposed transactions, including those for amounts below the threshold amount, may be subjected to review for potential enhanced due diligence.

The real-time initial analysis of proposed transactions is intended to thwart, or at least reduce, misuse of the money transfer system. However, sophisticated criminal networks can sometimes employ strategies to avoid detection at the initial stage, and some transactions will be processed without the real-time initial analysis identifying any problem with the particular transaction. For example, criminals have been noted to use multiple senders to make multiple small transfers in order to avoid detection.

In view of the millions of money transfer transactions that are made weekly or even daily, links between actors within an organized network can be impossible for a human analyst to detect. As such, in a preferred embodiment, a consumer-side analysis tool can use statistical review of transaction data concerning completed transactions, which is obtained from the transactions database, to identify potentially-suspicious behavior. Once potentially-suspicious behavior is identified, a human financial analyst that has been trained to identify suspicious patterns indicating abuse of the system can be brought in.

In preferred embodiments, the system 30 periodically runs a consumer-side analysis tool 90, such as beginning at a prescribed time every day, to autonomously search for and find patterns in processed transactions (including, in some embodiments, rejected transactions) that would indicate suspicious behavior. Preferably, every transaction of the previous day, and for a period previous, will be included in the periodic analysis, which will analyze transactions in view of one or a plurality of business rules, each of which presents particular criteria. The analysis tool flags suspicious patterns based on whether transactions satisfy the criteria of one or more of the business rules. Additional information is aggregated concerning flagged patterns in order to facilitate human review, specifically a “Level 2” review performed by a trained financial investigation unit (“FIU”) analyst who may be part of the Compliance department of the money transfer organization.

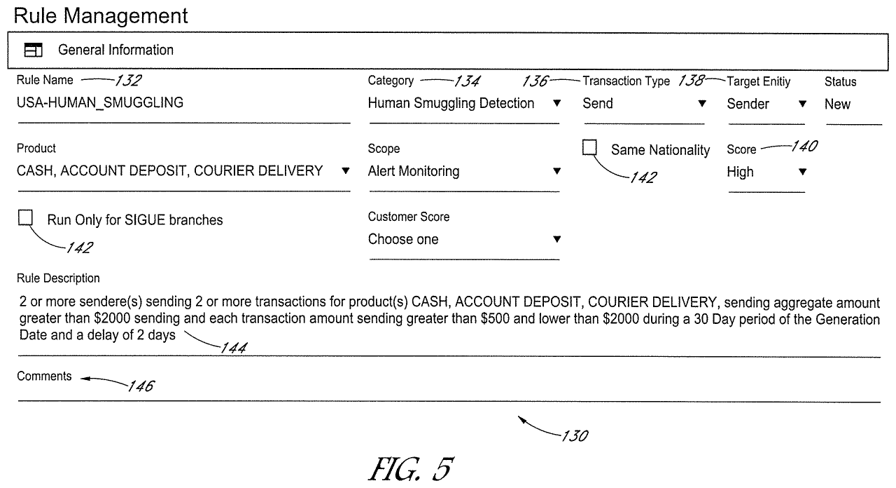

FIG. 4 illustrates a flow chart showing an exemplary embodiment of components and system flow that can be used to implement the consumer-side analysis tool 90 of the present disclosure. In some embodiments, the analysis tool 90 can include its own analysis database (as) 92, which can be one or more of the system's internal databases 36. In some embodiments, the analysis tool 90 does not need to maintain direct communication with transactions database 50. Instead, transaction data from the transactions database 50 can be periodically transferred to an analysis database 92. For example, the transaction data can be extracted on a weekly or daily basis from the transactions database 50, copied, and saved in the analysis database 92. The transaction data can then be analyzed for potentially suspect transactions by applying business rules to the transaction data. If potentially suspect transactions are not found, then the transaction data can, in some embodiments, be deleted from the analysis database 92 in order to preserve storage space for additional information. In other embodiments, the analysis tool 90 can directly access the transactions database 50 as needed.

In a preferred embodiment the analysis tool 90 accesses money transfer transaction data and evaluates the data in view of a set of preset business rules. The business rules can correspond to preset search criteria that correspond to potentially suspicious patterns of money transfers. Potentially suspicious patterns may include, for example, a single sender sending money to X number of different recipients within a time period of Y days, a single sender sending an aggregate of $A amount of funds in a time period of Y days, or a single sender having transactions with multiple different agents within a time period of Y days. Additional business rules considerations are contemplated, and additional embodiments are discussed below.

In the illustrated embodiment, upon start of the consumer-side analysis tool 90, a set of business rules relevant to the particular analysis is identified 94. Selection of business rules can be based on various criteria. In one embodiment, the analysis tool is run for individual countries, and each country has a set of business rules associated with that country and tailored to that country's laws and company policies concerning that country. In additional embodiments, another set of business rules can be tailored to identifying patterns that match a particular class of potential crime (i.e, money laundering, human trafficking, etc.) Thus, in some embodiments the analysis tool 90 can be run using only the business rules relevant to a particular class of potential crime.

Once the relevant set of business rules for the analysis has been identified 94, the analysis tool 90 accesses 96 the transaction information for the relevant review period, and evaluates 98 all transactions in view of a first one of the business rules. If the first business rule is satisfied 100 by transaction data, the system generates an alert 102. Generally, but not always, it will take several transactions (the “triggering transactions”) considered together to satisfy a business rule. In one embodiment, the transactions that together satisfy a business rule are considered the “origin transactions”. Preferably, the alert will be tagged to both the business rule and the origin transactions.

After review of the transaction data in view of the first business rule is complete, the system will determine whether a second business rule is available to be evaluated 104. The analysis will then proceed to the second business rule 98, and so on, until the system determines that every business rule in the set has been reviewed in light of the updated transaction data.

Over the course of its periodic analysis, multiple business rules sometimes will be satisfied, generating multiple alerts. While some of these alerts may have different origin transactions, at times multiple alerts could share one or more origin transactions. Preferably, alerts that share one or more origin transactions will be identified and grouped together depending on the scope of the pre-defined business rule 106.

In a preferred embodiment, alerts are generated 102 automatically by the analysis tool. Such alerts flag indicators of unusual behavior, but typically aren't definitive in determining whether the transaction, or group of transactions, are suspicious. Thus, alerts are flagged for analysis by an FIU analyst, who will conduct a Level 2 review. To facilitate such review, a case is generated 110 concerning each alert, or group of alerts. Preferably, the system automatically generates 110 such cases. Notably, however, sometimes an alert may be related to a case that has already been generated. Accordingly, before creating a new case, the system preferably will check 108 whether the alert is related to a case that has already been created. If so, the pre-existing case may be updated 109 to reflect the new, related alert. For example, if a newly-generated alert includes one or more transactions or individuals (such as the remitter, beneficiary, agent or paying agent) that are already part of an existing open case, that open case may be updated to add the newly-generated alert rather than generating a new case. In another embodiment, rather than update an existing case when a related alert is generated, a new case will be generated for the new alert, but the new case will include a note or flag identifying the possible relationship with the existing open case, and similarly the existing open case may be updated with a note or flag identifying the new case and its possible relationship to the existing open case.

If there is not already an open case related to an alert, or group of alerts, the system will create a case 110 and may assign 112 the case to an FIU Analyst for Level 2 review. Alternatively, the system may add the case to a register, from which the case may be automatically or manually assigned 112 to an analyst. Creating 110 a case preferably involves not only creating a new file, but includes aggregating information 111 that will be useful to the analyst in order to help the analyst identify potential suspicious cooperation between multiple individuals. Preferably, a Level 2 review will be performed using more information than was used to determine whether the triggering transactions triggered the business rule. Specifically, the system 30 will access data from the transactions database 50 to obtain transaction information about other individuals and transactions that may relate in some way to individuals and transactions involved in the triggering transactions. Such access and aggregation methodology can be considered a “link analysis” in which the system identifies links between the triggering transactions of the alert and other transactions in the database. In one example, for each remitter in the triggering transactions, the system may identify every beneficiary to which that remitter has sent money in the last 6 months (even though the triggered business rule may address a lesser time period of, for example, several days or weeks). Similarly, for each beneficiary in the triggering transactions, the system may identify every remitter and/or paying agent from which each beneficiary has received money in the last 6 months. The system can also identify other transactions in the last 6 months (or other period, as desired) tied to other information from the triggering transactions, such as the remitter's address, other contact information, transactions by the same agent that took place within a few minutes of one of the triggering transactions, or other possibly-linking information, or the like. The system can also identify previous cases within which each individual may previously have been named. Notably, the criteria for aggregating linking transactional information can be determined by the organization based on experience, and may be saved in one or more internal databases 36. Further, in some embodiments, the linking information that is sought can be specific to the business rule that triggered the alert.

Notably, in a preferred embodiment, the Level 2 review is configured to aggregate information that may reveal connections, or links, between individuals that could not reasonably have been identified or appreciated by simply reviewing the propriety of one transaction at a time, or even by reviewing the group of triggering transactions. In an example in which the triggering transactions all involved a single remitter (remitter A) but some transactions were directed to different beneficiaries (including, among others, beneficiaries X and Y), aggregation of data that identifies every remitter from which the beneficiaries received money may reveal, for example, that beneficiaries X and Y received money from both remitter A (as already known from the triggering transactions) and another remitter (remitter B) within the last M months. Thus, a link between remitters A and B is identified that could not have been found simply by reviewing the group of triggering transactions that triggered a business rule. This newfound connection can help the FIU analyst explore and possibly identify individuals working in concert to criminally abuse the money transfer services.

Continuing with reference to FIG. 4, the assigned analyst can access 114 the case via a user interface 54 such as a computer workstation. Preferably the expanded identification of possibly-related individuals from the triggering transactions are presented graphically, with the FIU analyst being able to access individual transactions via clicking on links. Also, preferably the case includes information about the business rule(s) that triggered creation of the alert(s), including what kind of suspicious behavior (i.e, money laundering, human trafficking, etc.) is associated with the rule. The analyst will review 114 the aggregated information in view of the patterns associated with the triggering suspicious behavior, and make an initial determination 116 whether or not the case presents suspicious activity. If not, the analyst preferably will input notes regarding her decision, which notes will be saved in the system, and will close 118 the case. However, if the analyst determines that the case presents suspicious behavior, or at least merits further review and/or action, the analyst may input a determination of such, and escalate the case for further 120, or Level 3, review and/or other action.

During a Level 3 review, additional data may be obtained, leading to more concrete determinations. For example, with reference to the example above, further information may be obtained concerning transactions involving remitter B, possibly identifying additional individuals having connections with one another. As a result of Level 3 review, an analyst (who may be a supervisory analyst different than the originally assigned analyst) may determine that the level of suspicion is sufficient to generate 122 a Suspicious Activity Report (SAR) for submission to law enforcement, or that the organization should take internal action 124 concerning a particular remitter (or other individual) such as adding the individual to the money transfer organization's internal block list. Further, an analyst may determine that the level of suspicion doesn't merit generation of a SAR, and will close 126 the case, but tag the case to the individuals associated with the triggering transactions so that if and when those individuals are part of another case, a link to the previous, now-closed, case will be provided.

In additional embodiments Level 3 review may lead to the creation and storage of an internal report 128 for documentation, further review and/or follow up, or other purposes. For example, the internal report can be used for training purposes with analysts or agents or for provisioning of a report to government agencies for follow up concerning potential criminal activity. The internal report can be generated and stored in a computer readable medium, such as the analysis database 92, ready for exporting when needed.

Data from escalated cases or the internal report can be registered and exported as a convenient file format for ease of transfer and access. For example, the cases can be exported as text (e.g. TXT), comma separated value (e.g. CSV), or other file formats (e.g. XLS).

In some embodiments, new cases that involve individuals linked to previous-but-now-closed cases may preferably be assigned to the same analyst that handled the previous case.

As discussed briefly above, the business rules can include considerations to detect possible unusual activity in senders and beneficiaries. Such business rules can be run via SQL server stored procedures that were created according the criteria defined. Potentially, hundreds of business rules can be created, with each business rule designed to identify a particular activity or fact situation that has been found to be related to a particular class of criminal activity. Business rules can also be tailored to specific geographical areas, such as countries, and customized to work with local financial laws as well as local cultural norms.

In a preferred embodiment, the money transfer organization system 30 works with a user interface 54 that enables a user to access the system 30 via a workstation or the like to view or modify existing business rules and/or to create new business rules. Most preferably, the system 30 is configured to have a graphical user interface that enables a user to work on business rules without requiring advanced knowledge of database programming. For example, in a preferred embodiment a graphical interface enables a user to configure business rules via simple graphical structures such as check boxes, sliding displays, and drop-down menus.

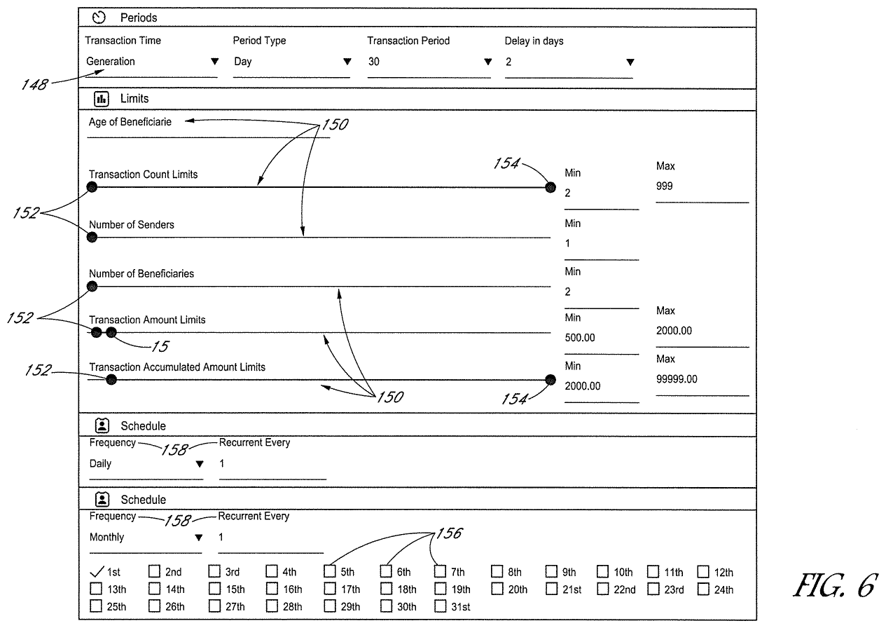

With reference next to FIG. 5, a screen shot of one embodiment of a business rule management interface 130 is depicted. As shown, each business rule preferably has its own unique name 132, which can be defined by the user at a text box. Additional aspects of the business rule can be defined by the user choosing one or more aspects from various drop-down menus. For example, each business rule preferably is tied to a category 134 of financial crime, meaning that the rule relates to behavior/patterns that are typically associated with the selected crime. Other features include, for example, the type of transactions 136 and products to which the business rule applies, the entity 138 targeted by the business rule, and a risk score 140 associated with the business rule, as some business rules are tied to more risk-suggestive behavior than others. Check boxes 142 are provided for further narrowing the business rule to specific situations or facts, such as whether the rule is run based only on particular branches of the organization and/or whether only senders/remitters of the same nationality are considered. As will be discussed further below, other screens and subscreens enable the user to configure the particulars of the business rule, but preferably the management interface generates a rule description 144 that describes the factors and criteria for triggering this particular business rule. In the illustrated embodiment, the management interface also accommodates text entry of user comments 146. Such comments may not be reflected in the rule itself, but can be provided by user(s) in the development and modification of the business rule over time. Preferably, business rules can be grouped and/or searched in accordance with any of the fields on the screens. For example, if a user wishes to review all of the business rules relating to the category of human trafficking, a search for same using the financial crime category field would yield all of such rules.

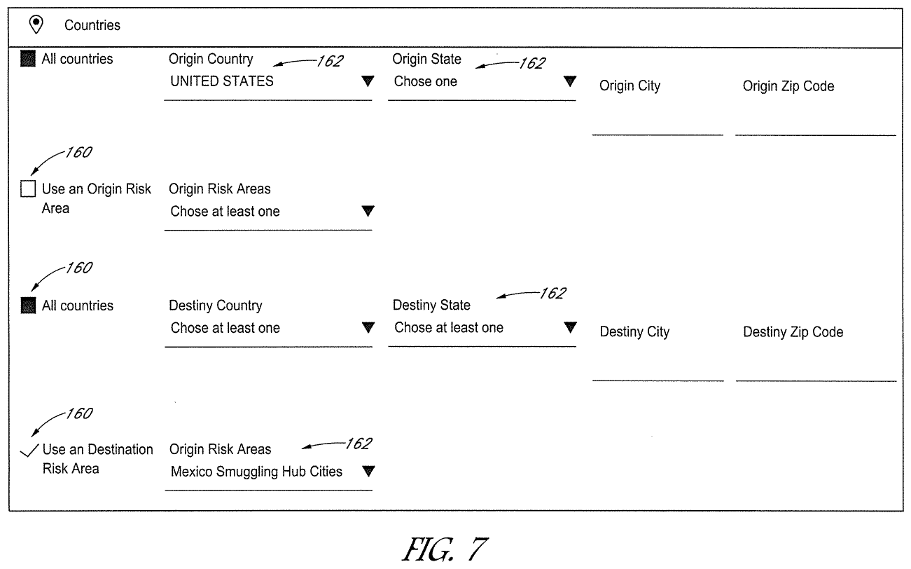

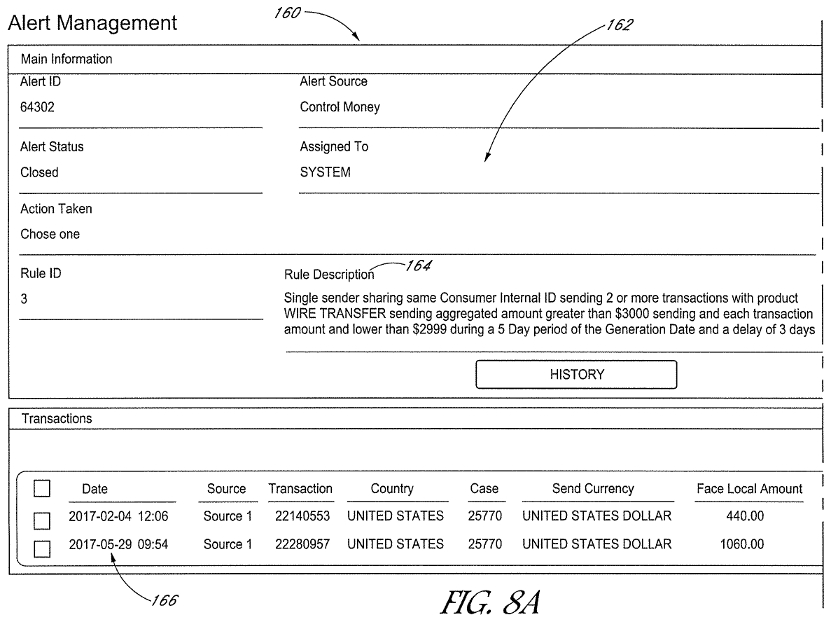

With reference to FIG. 6, a plurality of subscreens are depicted to show how a user may configure business rules. For example, a series of drop-down menus 146 can be manipulated to define the period, or date range of transactions, that are considered by a particular business rule. The user can also set a delay before new transactions will be evaluated in an analysis, such as 2 days. As such, an analysis will evaluate transactions that were created beginning 2 days (the delay) before the analysis date. A series of sliding displays 150 can enable the user to define ranges (including minimum set points 152 and/or minimum 152 and a maximum set points 154) of particular criteria that are employed in defining the rule. For example, in the illustrated embodiment, sliding displays 150 are used to define the rule as requiring at least 2 transactions sending an aggregated amount greater than $2,000, using only transactions between $500-$2,000. Notably, the settings in the illustrated sliding displays, check-boxes, drop-down menus, and the like, preferably are used by the system to construct the rule description 144.

In a preferred embodiment, the rule definition screens and subscreens may have options that do not necessarily have to be used. For example, in FIG. 6 there is a sliding display giving the option for selecting a range of ages of the beneficiary for consideration in the business rule analysis. The option has not been selected in the illustrated screen, and thus is not considered in the rule description or rule criteria in the example.

With continued reference to FIG. 6, the user may also manipulate display structures including check-boxes 156 and drop-down menus 158 to establish a schedule for running the particular business rule.

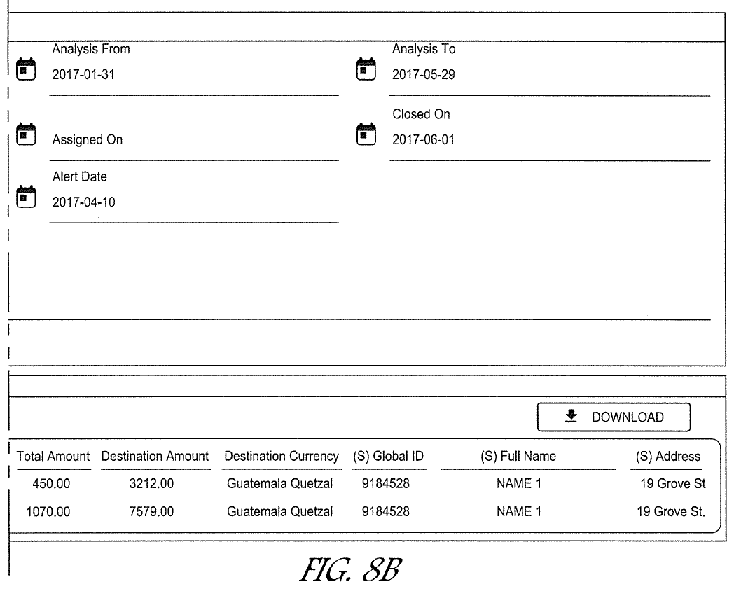

With reference next to FIG. 7, additional subscreens may be employed to further narrow the scope of the business rule with regard to specific criteria. For example, the illustrated subscreen identifies possible criteria concerning particular countries that can be included in a business rule. In order to have the business rule consider such criteria, the user can select a check-box 160 to activate the consideration, and further narrow the consideration via a drop-down menu 162 and/or text entry boxes (for considerations such as a particular zip code). In the illustrated embodiment, the user has activated the check box so that the business rule will consider transactions sending money to a defined destination risk area, and selected the “Mexico Smuggling Hub Cities” option from the drop-down menu. It is to be understood that the drop-down menus 162 provide options relevant to the criteria, which options are defined (and saved) by the system 30, such as within a system database 36. Thus, the business rules may rely on criteria defined by other parts of the system 30, which criteria can be updated without requiring update of individual business rules. For example, if, based on information received from law enforcement, a representative of the organization accesses the database 36 defining risk areas and adds another city to the “Mexico Smuggling Hub Cities” list, the current business rule is automatically updated, as the drop-down option references this independently-updated, and independently-saved data structure.

It is to be understood that additional screens and subscreens incorporating display structures as discussed above, as well as additional display structures, can be employed to enable a user to configure business rules without requiring such user to perform database program coding. Also, as discussed, at least some of the display structures (such as the drop-down menus) can reference lists or other types of data structures that are defined by the system independently of the business rule, and can be updated independently.

Some of the criteria that can be selectively used and adjusted while configuring a business rule include, for example:
Define the period of time for transaction review;
Accumulated amount or number of transactions by sender and/or beneficiary over the defined period of time;
Range of min and max number of transactions, accumulated amount, individual transaction amount, number of remitters, number of beneficiaries;
Whether specific criteria apply to a remitter or beneficiary;
Whether evaluating incoming or outgoing transactions;
Consider transactions only from or to specific geographic areas, groupings of high-risk or low-risk areas that can be defined independently, or all countries; and
Schedule for running analysis of rule, such as over a rolling period of a specific number of days or at a specific time or times each period of days, months, quarters or years.

By configuring business rules using user interfaces consistent with the illustrated embodiment, users can easily create new rules and fine-tune such rules as needed. For example, criminal organizations are known to change procedures from time to time. As law enforcement notes changes in criminal behavior, existing business rules can easily be adjusted by personnel of the money transfer organization to reflect such new patterns. Additionally, in some embodiments a user can fine-tune a business rule and test it to determine its effectiveness. For example, if a certain period is already known to include instances of suspicious behavior, as well as known instances of non-suspicious behavior, the business rule can be adjusted in several ways so as to create multiple versions of the business rule. Each version can be run in connection with the certain period, and the user can determine which version most efficiently identifies the known instances of suspicious behavior, while minimizing flagging of behavior that, when investigated, was shown to not be suspicious. As such, the easily-configurable interface enables fine-tuning and testing of business rules to maximize their effectiveness and efficiency, and the time and effort of FIU analysts can be better employed in identifying cases likely indicative of suspicious behavior rather than clearing false-positives.

As described above, for Level II of you, a case is created 110 and possibly-related transactions aggregated 111 for review for the analyst. For example, if a business rule was satisfied because a single sender sent money to several different recipients within 1 week, then for Level 2 the analysis tool 90 can aggregate 111 and identify all other senders from which each original recipient received money, and will compile that information in the case. In this way, the analysis tool can provide a broader picture of specific patterns with some transactions, such as one or several senders sending money to one or multiple beneficiaries, where the transactions can be arranged to circumvent or avoid limits on money transfer requirements for customer due diligence (“CDD”) and enhanced customer due diligence (“ECDD”) associated with initial financial screening of at the time of the transaction.

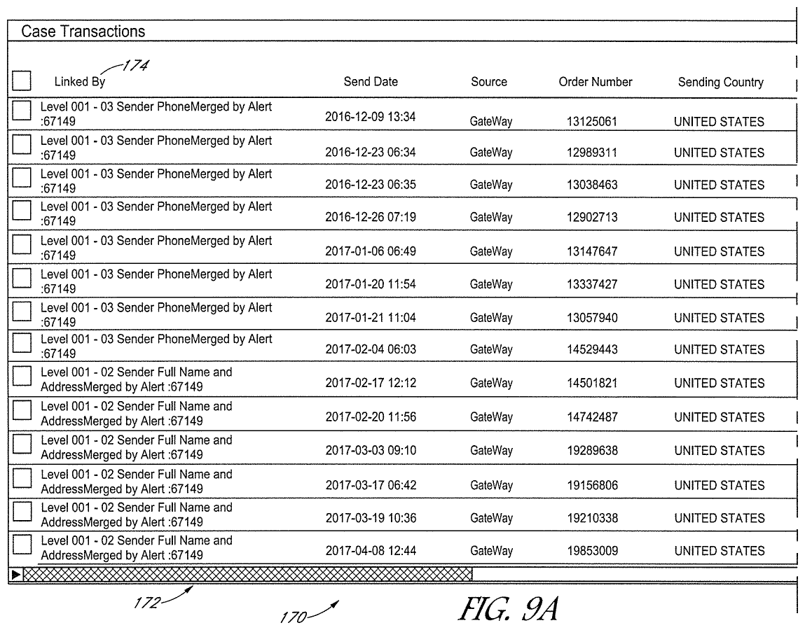

With next reference to FIG. 8, an exemplary alert management screen 160 depicting an alert can provide detailed information about a specific alert resulting from a triggered business rule. Preferably, a portion of the screen can present general information 162 about the alert, such as an alert ID, an alert source, a time frame for analysis, alert status, assigned-to information, assigned date, closed date, action taken, alert date, and rule ID. Additionally, a rule description 164 can be provided describing the specific business rule that triggered the alert. Also, a transactions section 166 preferably is provided to show all of the triggering transactions that, collectively, triggered the alert. Detailed information regarding each triggering transaction can be provided in the transactions section 166, including date of transaction, source of transaction, transaction number, origin country, case number, send currency, send money amount, destination money amount, destination currency, global ID number, full name, and address. Preferably, clicking on an individual triggering transaction provides access to a screen or screens providing even more detailed information. When the system 30 generates a case having aggregated data, preferably an indication of all aggregated transactions linked to a particular triggering transaction, including an indication of the information triggering the link (i.e., common remitter, beneficiary or the like) is indicated.

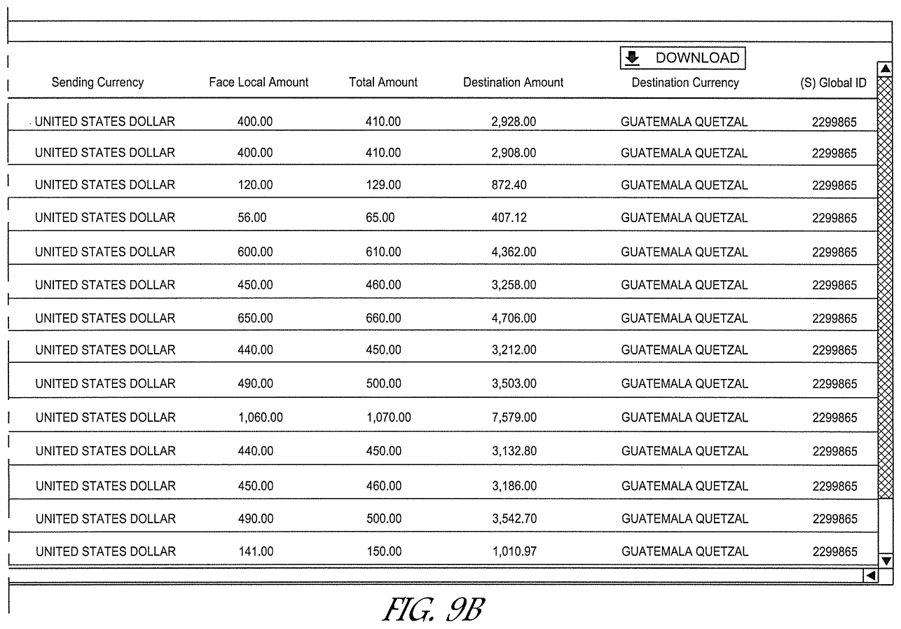

As discussed above, after an alert is triggered, a case is opened 110, and the system performs further review and analysis of the transactions database in order to identify and aggregate 111 additional, possibly-related transactions. FIG. 9 illustrates an exemplary embodiment of a case transactions screen 170, which lists the triggering transactions from the original alert as well as linked transactions 172 aggregated by the system for Level 2 review, along with an entry category 174 indicating how each particular transaction is linked to the triggering transactions. In the illustrated embodiment, the system has identified several other transactions that originated from remitters that claimed residence at the same address as that listed by the remitter in the alert. As shown, presentation of the transactions in the case enables an analyst to evaluate the link(s) between the transactions in order to spot patterns not necessarily visible from analyzing transactions concerning a single user.

Through an interface 54, the analyst can open the case, review the aggregated data and links, and eventually can decide 116 whether to close the case, refer it to further analysis, or refer it to law enforcement. The analyst can also use the analysis tool to enter comments that will be saved in relation to the case. The analysis tool 90 can allow for sending of a proposed Suspicious Activity Report (“SAR”) to the country's Money Laundering Reporting Officer (“MLRO”) or equivalent in the countries involved in the transactions.

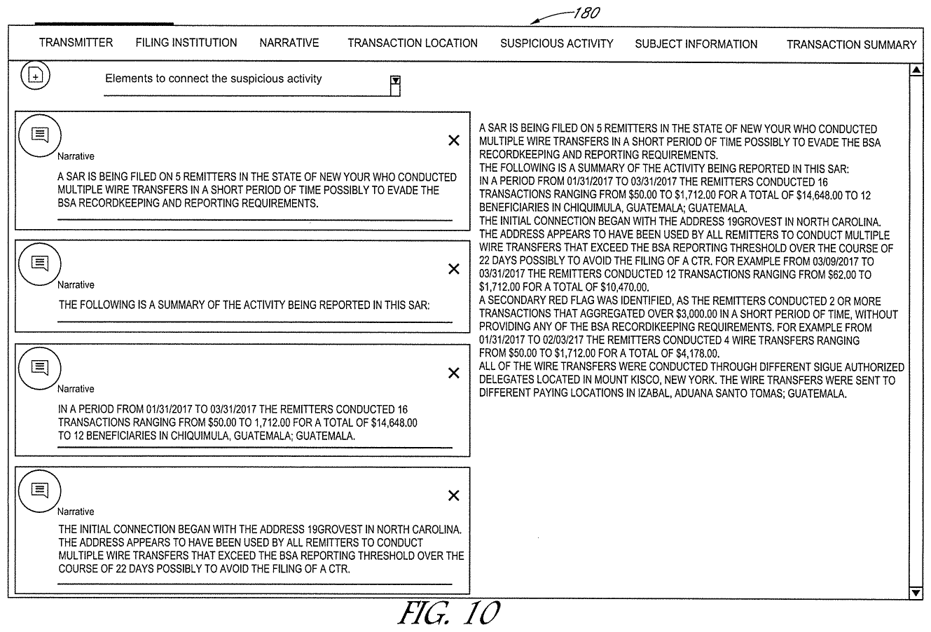

In the example depicted in FIGS. 8 and 9, an analyst presumably has reviewed the transactions in the case and determined that there is substantially suspicious behavior, because multiple remitters, all using the same residence address, have made several money transfers to multiple beneficiaries located in the same non-US city. As such, the analyst wishes to report the situation to the local government, such as via a SAR. Preferably, the system includes a form-generation module having various government forms, such as SARs, included. Such a form-generation module can thus import known information into an online SAR form upon direction to do so by the analyst. With reference next to FIG. 10, in one embodiment the analyst presents a textual narrative form 180 that can be submitted with or as part of a SAR and which describes in summary the reason(s) why the transactions indicate suspicious activity that justifies generation of a SAR. As shown, the textual description of FIG. 10 states, in summary form, the facts and connections that prompted creation of the SAR.

As discussed above, money transfer organizations typically use independent agents to interact directly with the remitters to intake and initially process money transfers, as well as to pay out such transfers to beneficiaries. These agents typically are not employees. Money transfer organizations thus recognize that the agents themselves can sometimes pose a risk of misusing the money transfer system. Such misuse may arise for a broad range of reasons. For example, an agent having insufficient business process control may be prone to mistakes, or an agent may coach remitters concerning reporting requirements and the like. In some instances an agent may even intentionally use the system fraudulently, either acting substantially alone or in concert with customers. However, a money transfer organization typically works with thousands of agents, who are involved with millions of money transfer transactions on a daily or weekly basis. Thus, practically speaking it would be impossible for an FTU analyst to identify high-risk agents necessitating closer review with any effectiveness.

In another preferred embodiment, a system and method is provided for leveraging saved transaction data to identify high-risk agents, and then performing more detailed analyses on such identified high-risk agents in an effort to contain risk and avoid inappropriate use of the money transfer system.

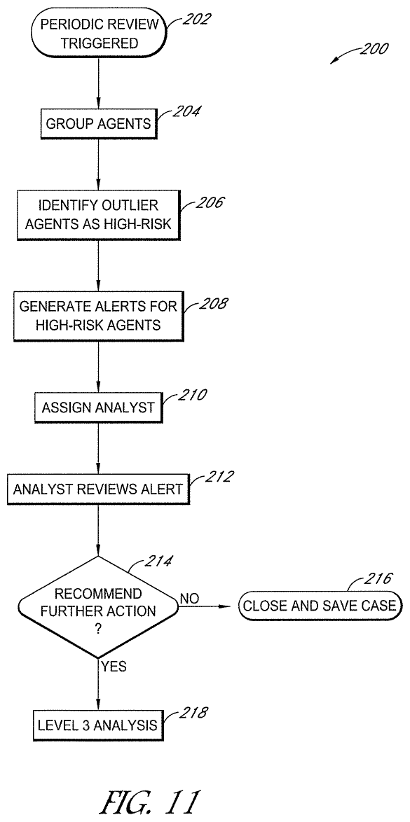

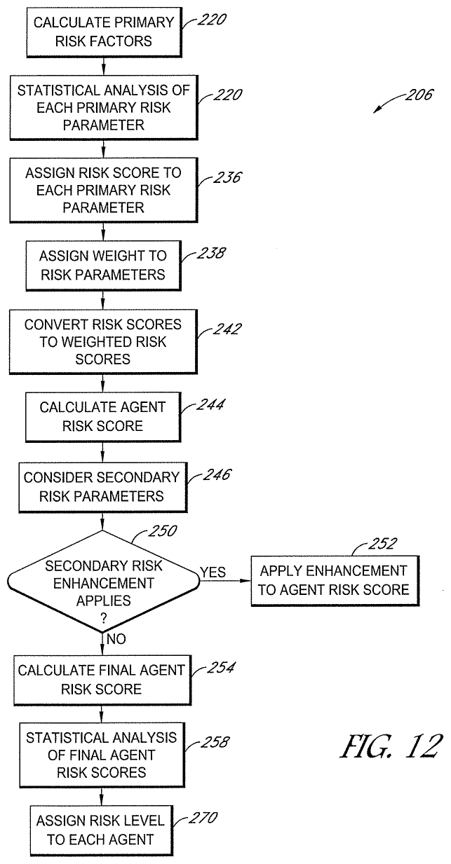

With reference next to FIG. 11, an agent risk assessment 200 is performed periodically by the system 30, such as monthly, in an effort to identify high-risk agents. In a preferred embodiment, the agent risk analysis involves a statistical comparison of agent activities in order to identify outliers, which have been found to have more of a likelihood of engaging in risky and/or suspicious behavior. In the illustrated embodiments, agents are compared to similarly-situated agents. Thus, preferably the agents are grouped based on a grouping criteria. In some embodiments, the grouping criteria is based on the geographic location of the agents. For example, one group may include all agents located in the US, and agents in other countries may be grouped with other agents in the same country or block of countries. In additional embodiments, the grouping criteria may be based on geographic locations corresponding to risk areas defined by the money transfer organization and saved independently of the transactions database 50. For example, as discussed above, the system may have a list of “Mexico Smuggling Hub Cities”, which list is maintained on the system 30 independent of the transactions database or of the various analyses (both consumer-centric and agent-centric) that are performed. Thus, in some embodiments, the grouping criteria may include such risk areas as the geographic location upon which agent grouping is based. For example, one group may include all agents that are located in the “Mexico Smuggling Hub Cities” risk area, and another group may include all agents that are located in other parts of Mexico.

It is also be to understood that grouping criteria may include non-geographic considerations. For example, in some embodiments, agent grouping criteria may be based on the length of time an agent has been associated with the money transfer organization, whether the agent's main business is money transfers or whether the money transfer service is a small part of the agent's main business, and by the size or nature of the agent's main business (i.e., whether the agent is a large, publicly-owned chain of retail stores that also offers money transfers or whether the agent is a small, family-owned store that also offers money transfers). Also, multiple factors can be considered in grouping criteria, such as a combination of geographic location and other factors mentioned above.

In still additional embodiments, agent risk analyses can be performed at different times using different grouping criteria. As such, an agent may be included in one group for one agent risk analysis, but in another group for another agent risk analysis. Agent risk analyses may be scheduled to be automatically performed periodically using a first grouping criteria, and to also be performed periodically (using the same or a different period) using a second grouping criteria. Also, it is to be understood that personnel of the money transfer organization may access the system and prompt or separately schedule an agent risk analysis (using the first, second, or perhaps a third grouping criteria) as desired. Preferably, when an agent risk analysis 200 is triggered 202, the agents to be reviewed are appropriately grouped 204.

With continued reference to FIG. 11, preferably the agent risk analysis comprises performing statistical analysis 206 of various risk parameters taken from transaction data over a time period to identify agents whose activity sets them apart from other, similarly-situated agents. More specifically, the agent risk analysis identifies agents whose activities show them to be statistical outliers relative to other agents in their particular agent group. Once such outlier agents have been identified 206, agent alerts are generated 208 for each of the outlier agents. In preferred embodiments, once an alert is opened, the system automatically accesses transaction data from the transactions database to aggregate additional transaction data that may be helpful for a deeper analysis of the agent. A human FIU analyst is also assigned 210 to the alert, and will review the aggregated data to perform a Level 2 review of the outlier, high-risk agent, searching for links and patterns indicating possible misuse of the money transfer system. While the specific information aggregated may differ, in principle this is similar in concept to the data aggregation performed for consumer-based cases as discussed above.

An analyst performing a Level 2 review of an outlier agent will have been trained to identify patterns associated with risky behavior, and will review 212 the aggregated data in the case to determine 214 whether further action is warranted. If no further action is warranted, the analyst will note the same in the alert file, which notes and alerts will be saved and closed 216, but preferably linked to an agent file saved by the system. In some instances the analyst may recommend further action 218, which can come in multiple forms, including a Level 3 review (agent investigation), in which even more information may be obtained, another analyst, or group of analysts may be called upon to review data, or in some instances the evidence may be clear enough to justify immediate action such as suspending or cancelling an agent, generating a SAR concerning the agent, or the like.

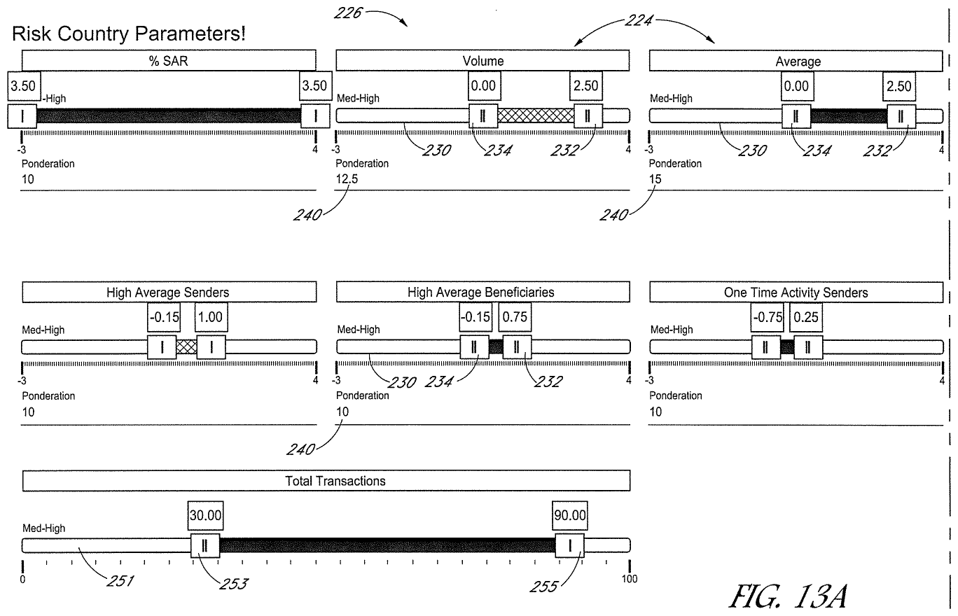

With additional reference to FIG. 12, embodiments of a statistical analysis 206 to identify outlier agents preferably involve the calculation 220 of several primary risk parameters that can be computed using transactional data, which can be obtained from the transactional database directly or via an analysis database. In one embodiment, the following primary risk parameters are calculated for each agent:
a. % of SARs: The percentage of transactions that have been conducted by the agent that have been involved in SARs.
b. Volume: The number of transactions that have been conducted by the agent within the analyzed period.
c. Average Amount: The average amount per transaction conducted by the agent during the analyzed period.
d. % below limits: This can indicate the percentage of transactions conducted by the agent that involve money amounts just below the limits and/or thresholds to require for additional information, such as CDD, ECDD, Consumer state-issued ID, etc.
e. High Velocity: This indicates the frequency that the agent conducts transactions by counting the average number of transactions per hour and/or the maximum number of transactions by hour that the agent conducted during the analyzed period.
f. Consecutive IDs: This can indicate the number of consecutive consumer ID numbers (IDs number from distinct consumers with changes only in the last two or three digits) used to conduct transactions by the agent during the analyzed period.
g. High Average Remitters (HAR): This identifies remitters who send more money than average remitters. In a preferred embodiment, the HAR indicates the percentage of remitters that, using this agent location, have sent money accumulating more than double (or some other multiple as desired) the country's (or other geographic area's) average accumulated amount by senders during the analyzed period. For example, if the average accumulated amount per sender in the UK during the period from June to August 2016 is 2,500 GPB, the analysis tool will consider remitters with a high average to be those whom have accumulated 5,000 GBP during the same period of time. Notably, in some embodiments calculation of the HAR will reference a data point saved elsewhere in the system—specifically, the average accumulated amount per sender in the geographic area. This data point can be periodically calculated by the system independently, and saved on the system, for the agent analysis to then reference and use to make the HAR calculation. Of course, in some embodiments, this data point can be calculated as part of the agent analysis. Preferably, however, the calculated data point used is the same for all relevant agents in the analysis.
h. High Average Beneficiaries (HAB): This identifies beneficiaries who receive more money than average beneficiaries, in a manner similar to HAR discussed above, but for beneficiaries rather than remitters. For example, the HAB can indicate the percentage of beneficiaries that, receiving money from this agent location, have accumulated over the double (or some other multiple as desired) of the country's (or other geographic area's) average accumulated amount by beneficiaries during the analyzed period. For example, if the average accumulated amount per beneficiary in the UK during the period from June to August 2016 is 2,500 GPB, the analysis tool will consider beneficiaries with high average to be those whom have accumulated 5,000 GBP during the same period of time. As with HAR, calculation of this data point can be calculated as part of the agent analysis or may be periodically calculated by the system independently, and saved on the system, for the agent analysis to then reference and use to make the HAB calculation. Preferably, however, the calculated data point used is the same for all relevant agents in the analysis.
i. One Time Activity Remitters (OTAR): This can indicate the percentage of remitters that, using the agent location, have conducted only one transaction during the analyzed period.
j. One Time Activity Beneficiaries (OTAB): This can indicate the percentage of beneficiaries that, receiving money from the agent location, have received only one transaction during the analyzed period.

Preferably, the agent analysis comprises the system accessing transaction data from the transaction database for a proscribed period (for example, the last 90 days in a preferred embodiment), and calculating 220 the primary risk parameters for each agent. As noted above, this may involve accessing and reviewing millions of transactions in order to extract the data and calculate 220 the primary risk parameters. Preferably, a statistical analysis 222 is performed for each primary risk factor within the relevant agent group. More specifically, the system performs a statistical normal distribution analysis for each of the primary risk parameters in the agent group, generating a “bell” curve. The position of each calculated primary risk parameter within the relevant distribution is calculated for each of the agents. In a preferred embodiment, for each calculated primary risk parameter of each agent, the number of standard deviations from the average is identified. This can help identify outliers, which can be associated with increased risk. Specifically, the higher the number of standard deviations from the average, the more of an outlier a particular primary risk parameter calculation is, thus suggesting greater risk.

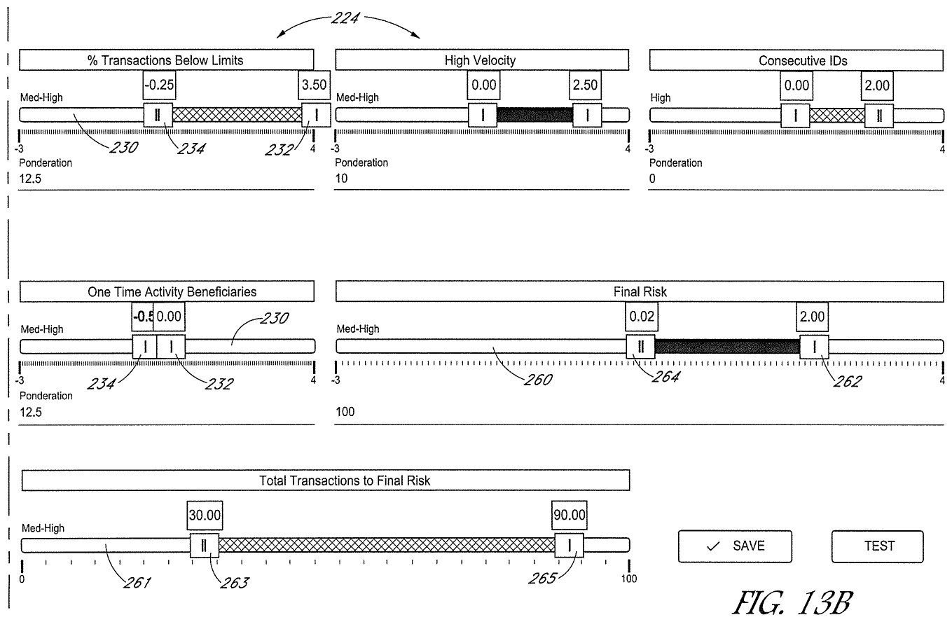

With additional reference to FIG. 13, the system preferably is configured to enable a user to both define 224 primary risk parameters and define how such primary risk parameters may be used in the agent analysis. In the illustrated embodiment, a risk parameter configuration interface screen 226 enables a data specialist of the money transfer organization to interface with the system and adjust aspects of agent analyses, particularly in connection with risk parameters.

In the illustrated embodiment, for each of the primary risk parameters a bar 230 is provided having two sliders 232, 234. The illustrated bar 230 extends from −3.5 to 3.5, which corresponds to the number of standard deviations from the average of a statistical bell curve. A first one 232 of the sliders (high-risk slider) can be set at a position on the bar 230 defining a high-risk setting, and a second one 234 of the sliders (medium-risk slider) can be set at a position on the bar 230 defining a medium-risk setting. A primary risk parameter calculation whose number of standard deviations from the average is greater than the value at which the first slider 232 is set is thus defined as being “high risk”; a risk parameter calculation whose number of standard deviations from the average lies between the values at which the first and second sliders 232, 234 are set is defined as being “medium risk”; and a risk parameter calculation whose number of standard deviations from the average is less than the value at which the second slider 234 is set is defined as being “low risk”.

The positions of the first and second sliders 232, 234 can be set by an experience data specialist, based upon experience and training in money transfer risk analyses. In some embodiments, however, an effort is made to set the first slider 232 at a number of standard deviations from the mean that will be exceeded by only about 5% of primary risk parameter calculations. Thus, only calculations that are clear outliers from the average will be identified as high risk. And the second slider 234 is set at a number of standard deviations from the average that will be exceeded by only about 15-20% of primary risk parameter calculations so that 10-15% of such calculations will fall within the “medium risk” range. However, it is to be understood that such settings can be customized as desired. Also, in additional embodiments, the bars 230 and sliders 232, 234 can be modified to be put in terms of percentages rather than standard deviations. For example, the bar and 230 could be set to extend from 100% to 0%, and the first slider 232 could be set at 5% and the second slider 234 set at 20% in order to capture the top 5% of calculations as high risk and the next 15% of calculations as medium risk. Still further, in additional embodiments a greater or lesser number of risk definitions (i.e., one or more of ultra-high risk, high risk, medium-high risk, medium risk, medium-low risk, etc.) can be employed. Indeed, the present embodiment, which defines only classes of high, medium and low risk, is but one example.

Preferably, a risk score is assigned 236 by the system 30 to each primary risk parameter according to the defined risk as calculated based on the statistical analysis. In the illustrated embodiment, a low-risk calculation is assigned a risk score of 1; a medium-risk calculation is assigned a risk score of 2; and a high-risk calculation is assigned a risk score of 3.

In some embodiments certain primary risk parameters may prove more important in indicating risk than others. Thus, such primary risk parameters may be weighted more heavily than others. The illustrated embodiment employs a weighting system in which each primary risk parameter is assigned 238 a percentage, or ponderance 240, of total risk. More specifically, all (i.e., 100%) of the risk is distributed among the primary risk parameters, with each primary risk parameter receiving a portion. Thus, one primary risk parameter may be assigned 15% of the risk, or a ponderance of 0.15, while another primary risk parameter is assigned 10% of the risk, or a ponderance of 0.10. All of the ponderances assigned to the primary risk parameters will add up to 100%, or 1.00. The ponderance 240 for each primary risk parameter is multiplied by the associated assigned risk score to convert 242 the rescore to a weighted rescore. An agent risk or for the particular agent is then calculated 244 by adding all of the weighted risk scores In the illustrated embodiment, the weighted agent risk score will be a number between 1 (i.e., low risk) and 3 (i.e., high risk).

With continued reference to FIG. 13, preferably the risk parameter configuration interface screen enables a data specialist to assign, and modify, each of the ponderance values 240. Such ponderance values preferably are determined based upon experience. For example, a statistical analysis may reveal that outliers in one primary risk parameter calculation are associated with 50% more SARs than outliers in a second primary risk parameter, and thus the ponderance for the first risk parameter is set at a level 50% higher than that of the second risk parameter. In some embodiments the ponderance values remain the same unless and until experience dictates that they be changed. In other embodiments, different ponderance assignments may be employed, for example, for different groups. For example, experience may demonstrate that the relative indication of risk of specific primary risk parameters may be different in different groups of agents, such as in different countries. Also, as with the business rules discussed above, the illustrated interface lends itself to experimentation and testing in order to fine-tune its effectiveness by using similar procedures as discussed above.

In some embodiments, still additional risk parameters are factored into the agent risk score. For example, a second group of risk parameters (secondary risk parameters) can be considered 246 after the agent risk score has been initially computed 244. In a preferred embodiment, the system 30 analyzes one or more secondary risk parameters against a risk criteria to determine 250 whether the secondary risk parameter(s) has satisfied the risk criteria such that the agent risk score should be enhanced. If the system determines that the risk criteria is satisfied, enhancement is applied 252 to the agent risk score to calculate 252 a final agent risk score. For example, in one embodiment, the second group of secondary risk parameters includes calculation of each agent's main destination country, which is defined as the country (or geographic region) to which the agent's business has directed the highest number of money transfer transactions (or, in some embodiments, aggregate money sent) during the analysis period. The system determines the main destination country, and then checks whether the main destination country is included in a list of high risk countries that is independently maintained on the system. If the main destination country is included in the list of high risk countries, then an enhancement of 0.5 risk points is added to the weighted agent risk score. In some embodiments, the main destination country can lead to a reduction in agent risk score. For example, if the agent's main destination country is included in a list of low risk countries that is independently maintained on the system, then an enhancement of 0.25 risk points may be subtracted from the weighted agent risk score to calculate the final agent risk score.

In some embodiments, the second group of risk parameters can include only a single secondary risk parameter. In other embodiments, the second group of risk parameters can include multiple secondary risk parameters. For example, in one embodiment, if the system determines that the agent has been associated with the money transfer organization for less than 6 months, 0.3 risk points are added to the weighted agent risk score. Further, in additional embodiments, calculations of secondary risk parameters can also be subjected to statistical comparison with other agents within the agent group. For example, one of the secondary risk parameters to be calculated by the system could be the number of SARs that have been generated in the previous X months that have referenced transactions performed by the particular agent. Notably, this calculation may use data from the transactions database 50 or other databases 36. This secondary risk parameter can then be statistically analyzed in a manner similar to the first group of primary risk parameters as discussed above, with each calculation being defined as high risk, medium risk or low risk. In some embodiments, a high risk classification of this secondary risk parameter results in an enhancement adding 0.4 risk points to the weighted agent risk score, and a medium risk classification results in an enhancement adding 0.2 risk points to the weighted agent risk score. It is to be understood that the number of risk points added or subtracted to the weighted agent risk score as a result of analysis/calculation of any secondary risk parameter can be determined and modified as desired by the money transfer organization as a result of experience, testing, and the like. Also, in some embodiments the principle of applying additions or subtractions can be administered somewhat differently (such as varying the ponderance, affecting independent risk parameters, or the like). In some embodiments, a particular secondary risk parameter may be determined, based on experience, to correlate more to certain of the primary risk parameters than to others. Thus, in such embodiments, rather than modifying the weighted agent risk score, a result of a secondary risk parameter may lead to enhancement/modification of one or more of the primary risk parameters without affecting others, such as by modifying the assigned risk score(s) for the affected primary risk parameter(s), automatically modifying ponderance distribution, or the like.

In the embodiment illustrated in FIG. 13, a bar 251 and first and second sliders 253, 255 are provided for the secondary risk parameter “Total Transactions”. This secondary parameter is in recognition that an agent with relatively few transactions will have a lower risk than agents with many transactions. In this embodiment, the first and second sliders 253, 255 are set to percentages between 0 and 100%, with agents having a total number of transactions in the 30^{th} percentile or less (the shown position of the first slider 253) being in a low-volume group, agents having a total number of transactions in the 90^{th} percentile and above (based on the shown position of the second slider 255) being in a high-volume group, and the remaining agents being in a middle group. In an embodiment, for agents in the low-volume group, risk points could be subtracted from the weighted agent risk score and risk points can be added for agents in the high-volume group, while the middle group remains unaffected. Or, as just discussed, in some embodiments modifications can be made directly to specific ones of the risk scores assigned to primary risk parameters. For example, since “Volume” is already a primary risk factor, the “Total Transactions” secondary risk factor may be somewhat duplicative, and thus in some embodiments may not affect the Volume primary risk parameter, but experience may dictate that, for agents in the low-volume group, the “Consecutive IDs” primary risk factor score should be enhanced but the “Average” primary risk factor score should be reduced. Notably, a user can access and modify the bar 251, as desired. Further, such bars can be added for consideration in connection with additional secondary risk factors, such as those discussed above, and the settings of the first and second sliders 253, 255 for such secondary risk factors can be based on percentiles, as in the illustrated embodiment, statistical distributions standard deviations, hard numbers specifically input by a user, or other criteria as determined by user input.

Preferably, a final agent risk score is calculated from the initial weighted agent risk score enhanced by additions or subtractions due to secondary risk parameters. Such a final agent risk score is calculated 254 for each agent involved in the agent risk analysis.

In a preferred embodiment, after the final agent risk scores have been calculated, a second level 258 of agent statistical comparison is performed. Specifically, within each group, the final agent risk scores are statistically compared, again generating a bell curve statistical distribution. Once again, outliers are identified and labeled as being high risk. In an illustrated embodiment, and with reference again to FIG. 13, a bar 260 and first and second sliders 262, 264 can be provided in the risk parameter configuration interface screen 226 to determine threshold levels of standard deviations defining high, middle and low-risk final agent risk scores. In this manner a risk level is assigned 270 to each agent via the multi-level statistical risk analysis.

In some embodiments, secondary risk parameters can also impact calculation of the risk level. For example, FIG. 13 presents a bar 261 and first and second sliders 263, 265 for the secondary risk parameter “Total Transactions to Final Risk”. In a manner similar to the “Total Transactions” slider bar 251 discussed above, if an agent has comparatively few transactions it presents a lower risk, and thus even after the statistical comparison of the final agent risk scores, the assigned risk level can be modified based on the agent's position along the slider bar 261. In other embodiments, this secondary risk parameter can instead be applied to calculation of the final agent risk scores, and other secondary risk parameters that are somewhat related to one another (such as the “Total Transactions . . . ” parameters, which are based on the number of transactions by an agent) can be provided wherein calculations are applied at different points in the process. Also, it is to be understood that secondary risk parameters (and, for that matter, primary risk parameters) can be turned “on” or “off” for analyses. For example, a user may choose a configuration which uses the “Total Transactions” parameter, but not the “Total Transactions to Final Risk” parameter, or the opposite configuration, or a configuration using both. It is also to be understood that this example can apply to others of the secondary risk parameters, and such principles can be applied to use of primary risk parameters.

With continued reference to FIGS. 11 and 12, after a risk level has been assigned 270 to each agent, such assignments are saved in the system database. Further, an agent alert is generated 208 for each agent that has been assigned a high risk. As such, a human FIU analyst is assigned to more thoroughly review agents in an agent alert, which can be referred to as a Level 2 analysis 212.

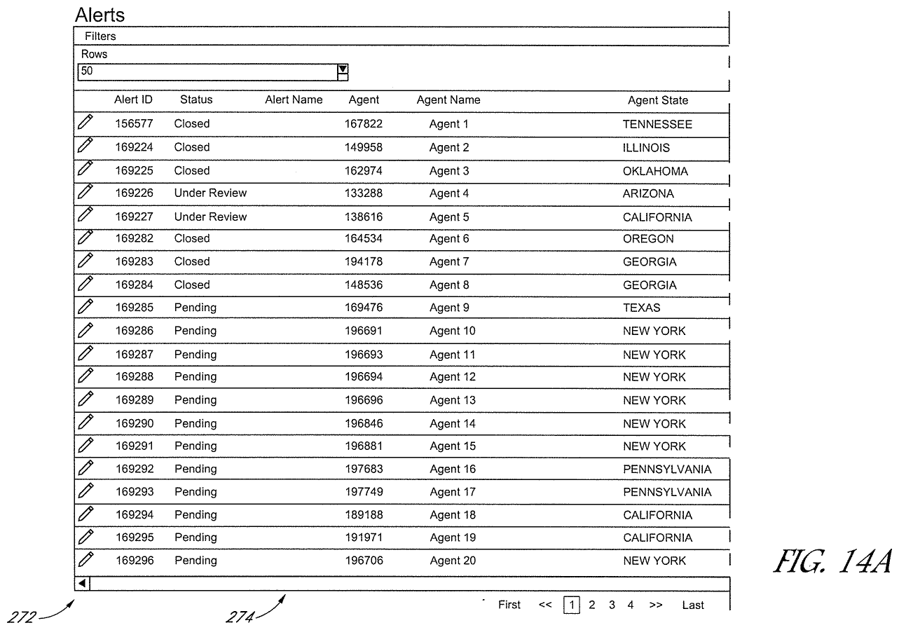

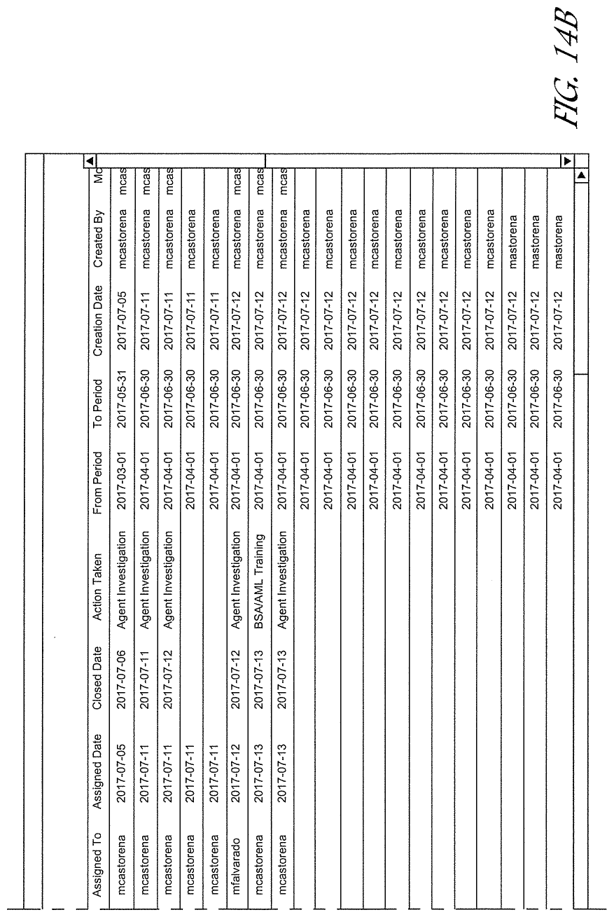

With reference next to FIGS. 14 and 15, a list 272 of agent alerts is saved and accessible on the system. As shown, the system keeps track of information about the alert, its status, action taken, the assigned analyst, and the like, which can be accessed via an agent risk assessment alerts results screen 274. By clicking on a listed alert, the analyst can access an agent alerts management screen 276 to access more detailed information 278 regarding the alert. Additionally, text entry boxes 279 are available for notes by an analyst regarding issues such as general activity red flags, destination countries activity, paying agents activity, and consumers activity.

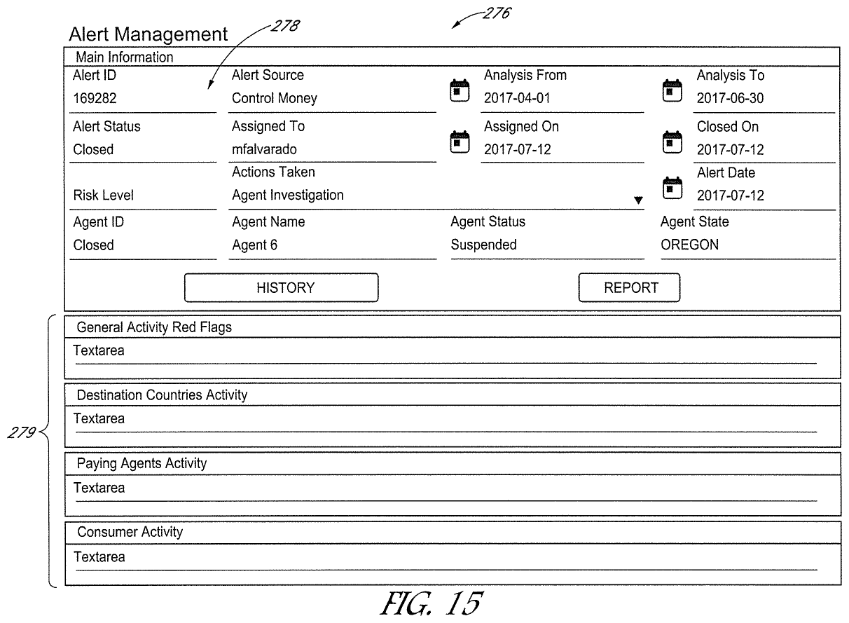

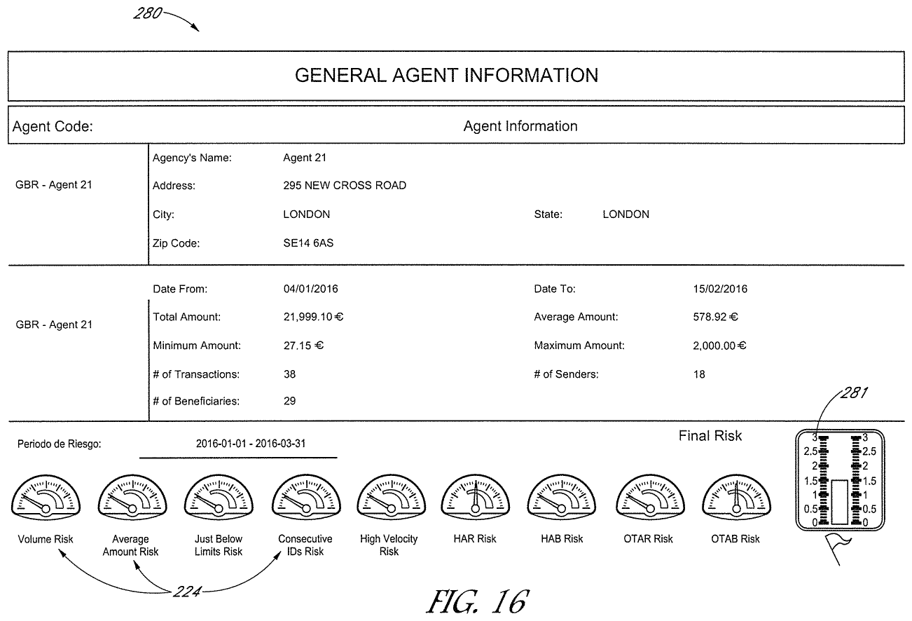

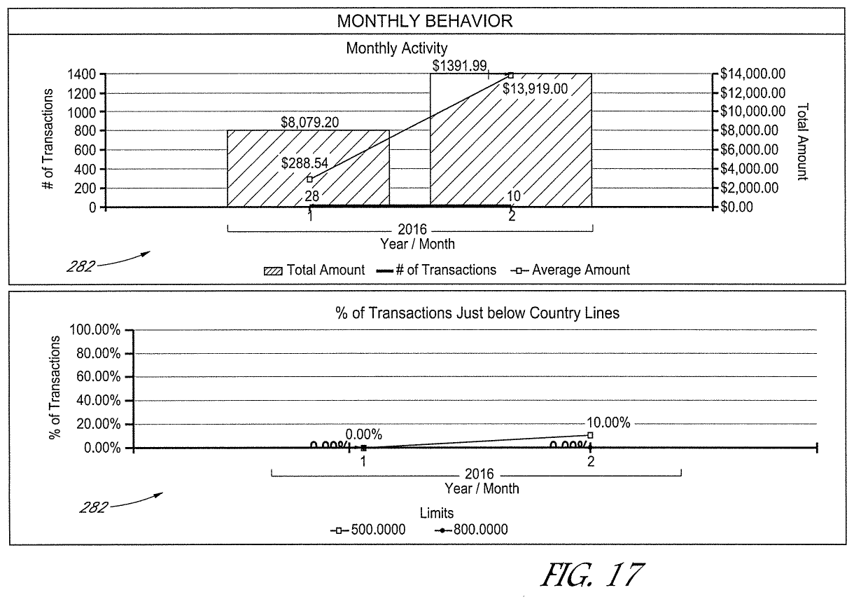

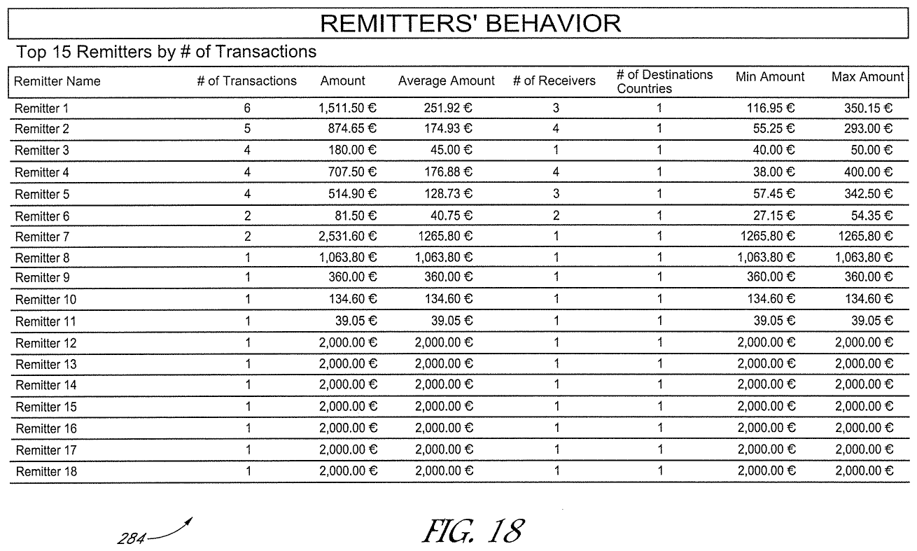

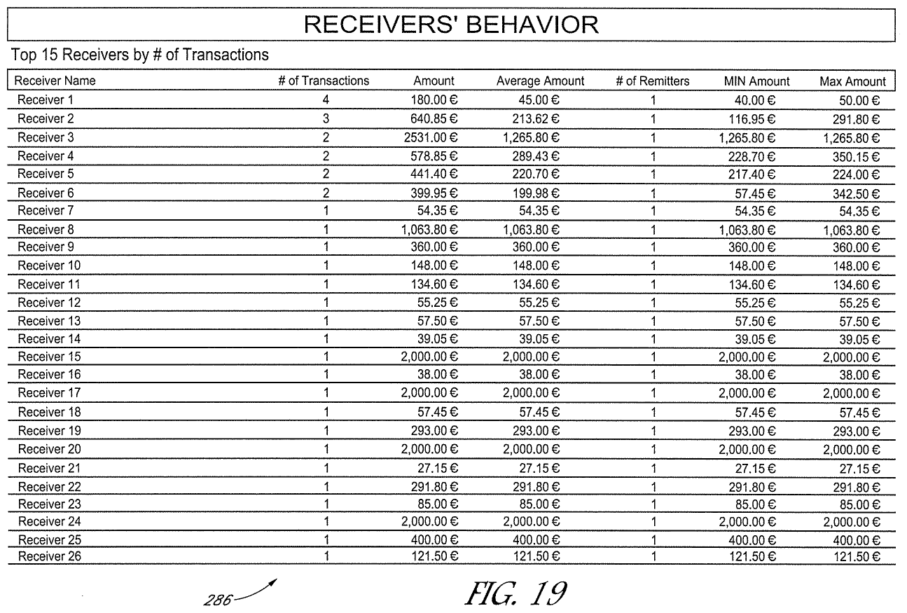

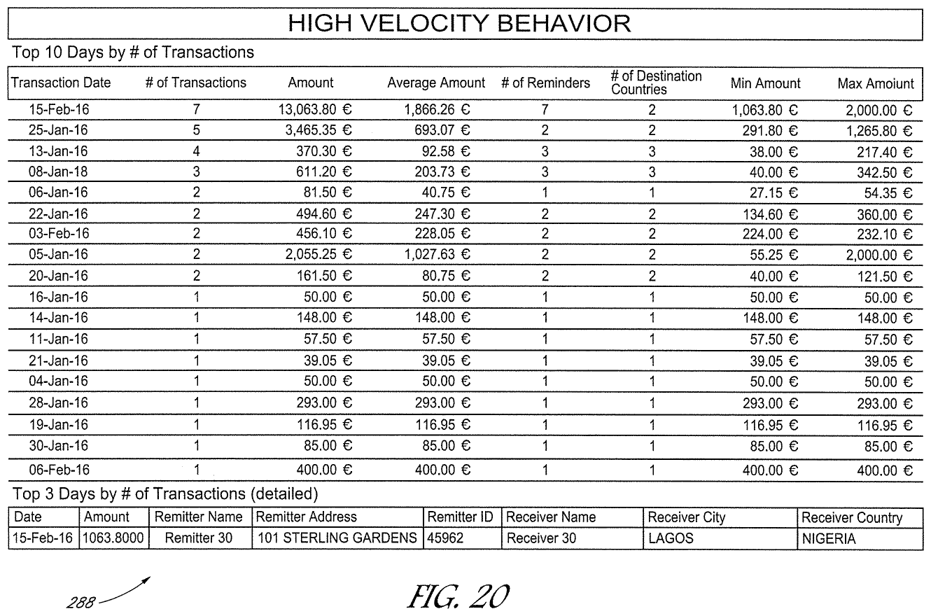

With additional reference to FIGS. 16-20, in a preferred embodiment, an agent alert triggers creation of a transactional behavior report 280 generated in connection with each agent alert. Such report will include information about the agent, including profile information and statistical information, the period of the analysis, and can include (as depicted in FIG. 16) information about the primary risk parameters 224 and the final agent risk score 281. Most preferably the level 2 agent alert report will aggregate substantial information concerning transactions performed by the agent in order to assist the analyst in identifying suspicious patterns. FIGS. 17-20 present example charts and lists that may be provided, such as charts 282 of monthly activity (FIG. 17) in connection with the primary risk parameters. Lists can also be provided, such as a remitter behavior list 284 showing, each remitter with which the agent has worked and providing aggregated statistics about such remitter (FIG. 18), and a beneficiary behavior list 286 showing each beneficiary from transactions processed by the agent and providing aggregated statistics about such beneficiary (FIG. 19). A high velocity behavior list 288 can present aggregated data concerning the days within the analysis period in which the agent had the most money transfer activity (FIG. 20).

In some embodiments, and in a manner similar to as discussed above in connection with consumer-side risk analyses, agent alert cases may aggregate additional transactions that may reveal links previously unidentifiable, such as other agents that share remitters and/or beneficiaries, other agents that may have experienced similar high volume activity during a similar time period, and the like. Analysts can determine if red flags, indicating a possible agent's coaching, participation and/or allowing consumers to circumvent compliance policies and controls, were detected during a period (such as 6 months) of transactions by using key indicators in the transactional charts and tables, such as those found in a Level 2 Transactional Behavior Report.

The Transactional Behavior Report can further include statistical and visual representations of:

i. General Behavior—daily, weekly and/or monthly charts concerning:
1. Number of Transactions
2. Total Accumulated Amount
3. Average Transaction Amount
4. Maximum Transactional Amount
5. Minimum Transactional Amount
6. Percentage of Transactions just below the limits

ii. Destination Country Behavior, which can include monthly charts showing, for example:
1. Top 5 Countries by Number of Transactions
2. Top 5 Countries by Total Accumulated Amount
3. Top 5 Countries by Average Transaction Amount
4. Top 5 Countries by Percentage of Transactions just below the limits

iii. Paying Agents Behavior, which can include monthly charts showing, for example:
1. Top 5 Paying Agents by Number of Transactions
2. Top 5 Paying Agents by Total Accumulated Amount
3. Top 5 Paying Agents Average Transaction Amount
4. Top 5 Paying Agents by Percentage of Transactions just below the limits

iv. Remitters and Beneficiaries Behavior, which can include, for example:
1. Top 15 Senders by Number of Transactions Table
2. Top 15 Senders by Total Amount Table
3. Top 15 Senders by Average Amount Table
4. Top 15 Senders by Number of beneficiaries used in transactions Table
5. Top 15 Beneficiaries by Number of Transactions Table
6. Top 15 Beneficiaries by Total Amount Table
7. Top 15 Beneficiaries by Average Amount Table
8. Top 15 Beneficiaries by Number of senders used in transactions Table
9. Senders sharing IDs Table

v. Top Days Analysis, which can include, for example:
1. Top 10 Days by Number of Transactions Table
2. Top 3 Days by Number of Transactions detailed table
3. Top 10 Days by Total Amount Table
4. Top 3 Days by Total Amount detailed table

It is to be understood that, in some embodiments, a transaction behavior report 280 can be generated for any agent upon request by an analyst or other system user. However, in embodiments employing an agent risk analysis 200, such reports 280 are automatically generated for agents identified as high risk in order to make the most efficient use of FIU analysts' time, so that they spend their efforts analyzing agents most likely to be misusing the system.

Preferably the system also allows analysts to access an agent profile that presents agent information maintained on the system. Such information can include identifying and profile data, but preferably also includes links to current and previous agent investigative alerts concerning the agent, as well as links to consumer cases that may have involved transactions performed by the agent. Thus, the analyst may consider data aggregated and presented in the report, but also may consider historical data concerning previous or concurrent agent alerts, consumer cases, and the like, which are all accessible via the system.

When suspicious activity is identified in Levels 1 and 2, analysts can escalate 218 further to Level 3 review (agent investigation) for even deeper analysis of the transactional behavior of the agent. Level 3 review can provide for analysis of an extended transactional activity using extended periods of time, such as 6-12 months of transactions. This analysis level preferably includes observation of the parameters of level two as well as analysis of consumer activity using link analysis and behavior indicators.

In some embodiments, a Level 3 analysis can include a more detailed investigation of the owner of the agent, and may include investigation of some facts that are not found on the money transfer organization's system. For example, in some embodiments, Level 3 analysis includes:

i. Investigation of agent owner activity, which can included review of transaction data to determine whether the owner of the agent is conducting transactions using the system, using the agent he owns or other agents.

ii. Criminal background checks of agent owner and/or key personnel, which can verify any information related to criminal penalties related with agent's owner and/or key personal.

iii. Media Screening, in which media is reviewed in an effort to identify information about the agent's business or agent's owner suggesting possible criminal or other suspicious or worrisome activity related to the agent.

iv. Mystery shopping, which can range from a mystery shopper simply observing the agent's business practices and processes to a mystery shopper tempting the agent to engage in inappropriate behavior.

In view of this analysis, or even simply in view of the Level 2 analysis, if the FIU analyst determines that a particular agent does, indeed, involve a high risk of misuse of the money transfer services, that analyst can make and send recommendations to take preventive and/or corrective measures to decrease the risk in transactions conducted by the agent. These measures can include, for example, supplemental agent training, program review, or agent cancellation. Additionally, the analyst can file a Suspicious Activity Report (“SAR”) against a consumer and/or an agent if suspect activity is uncovered.

Although the above exemplary screens provide certain information on certain screens, it is readily understood that different combinations of the information could be provided on the various screens for user accessibility. The screens may each be linked through selection of each of the various screens, either through the identified selection abilities or through additional selection buttons or tabs provided for the screens.

Although the above exemplary embodiments can provide for action in certain levels of review, it is readily understood that different combinations of the information could be provided at the various levels of review for user accessibility. There can be fewer levels of review, where relevant information can be presented at a lower level, or additional levels of review, where information can be further separated for higher levels of review.

Although this specification has discussed limited embodiments of analysis tools for analyzing and detecting potentially suspect consumer-side money transfer transactions and for identifying high-risk agents. It should be understood, however, that many modifications and variations will be apparent to those skilled in the art. Furthermore, it is understood and contemplated that features specifically discussed for analyzing the potentially suspect transactions or patterns in a consumer-side analysis may be adopted for inclusion with an agent risk analysis, and vice versa, provided the functions are compatible. Accordingly, it is to be understood that the analysis tools, components, and methods employing principles discussed herein can be embodied in other specific forms.

Although inventive subject matter has been disclosed in the context of certain preferred or illustrated embodiments and examples, it will be understood by those skilled in the art that the inventive subject matter extends beyond the specifically disclosed embodiments to other alternative embodiments and/or uses of the invention and obvious modifications and equivalents thereof. In addition, while a number of variations of the disclosed embodiments have been shown and described in detail, other modifications, which are within the scope of the inventive subject matter, will be readily apparent to those of skill in the art based upon this disclosure. It is also contemplated that various combinations or subcombinations of the specific features and aspects of the disclosed embodiments may be made and still fall within the scope of the inventive subject matter. Accordingly, it should be understood that various features and aspects of the disclosed embodiments can be combined with or substituted for one another in order to form varying modes of the disclosed inventive subject matter. Thus, it is intended that the scope of the inventive subject matter herein disclosed should not be limited by the particular disclosed embodiments described above, but should be determined only by a fair reading of the claims that follow.

What is claimed is:

1. A method for performing agent risk analysis for a money transfer organization in which a plurality of agents facilitate a high volume of money transfers from remitters to beneficiaries, comprising:
processing a high volume of money transfers in which each of the plurality of agents interacts with a plurality of remitters and/or a plurality of beneficiaries;
storing data concerning each of the money transfers in a transactions database;
performing an outlier agent identification analysis, comprising:
for each of the plurality of agents, aggregating data from the transactions database and using the aggregated data to calculate a plurality of primary risk parameters for a selected analysis time period;
applying a grouping criteria to each of the plurality of agents and, based on the grouping criteria, identifying a first group of agents and a second group of agents;
generating a primary risk statistical distribution for each primary risk parameter within each group, and identifying the disposition of each primary risk parameter of each agent within the primary risk statistical distribution;
in view of the primary risk statistical distribution, assigning a primary parameter risk score to each primary risk parameter of each agent, the primary parameter risk score being based on the extent to which the particular primary risk parameter is a statistical outlier relative to like primary risk parameters of other agents within the same group;
aggregating the primary parameter risk scores for each agent to define an agent risk score for each agent;
generating an agent risk score statistical distribution of agent risk scores within the same group, and identifying the disposition of the agent risk score of each agent within the agent risk score statistical distribution;
in view of the agent risk score statistical distribution, identifying outlier agent risk scores as agent risk scores that meet or exceed a threshold outlier status relative to other agent risk scores in the agent risk score statistical distribution;
identifying each agent having an outlier agent risk score as an outlier agent and generating an agent alert for each outlier agent; and
generating a report aggregating data from the transaction database concerning the outlier agent in each agent alert;
a human analyst reviewing the agent alert and recording observations about the outlier agent; and
saving data concerning each agent alert and analyst observations.

2. A method as in claim 1 additionally comprising a user accessing an agent analysis interface to define criteria for the outlier agent identification analysis.

3. A method as in claim 2, comprising assigning a first risk score to each primary risk parameter that lies at or more than a first primary threshold number of standard deviations from the mean of the primary risk statistical distribution.

4. A method as in claim 3, comprising a second risk score to each primary risk parameter that lies at or more than a second primary threshold number but less than the first primary number of standard deviations from the mean of the primary risk statistical distribution.

5. A method as in claim 4, comprising assigning a third risk score to each primary risk parameter that lies less than the second primary threshold number of standard deviations from the mean of the primary risk statistical distribution.

6. A method as in claim 5 additionally comprising the user accessing the agent analysis interface and setting the first primary threshold number and the second primary threshold number, and selecting each of the plurality of primary risk parameters from a list of potential primary risk parameters.

7. A method as in claim 3 additionally comprising the user setting the first primary threshold number for a first one of the primary risk parameters via the agent analysis interface.

8. A method as in claim 7, comprising setting the first primary threshold number so that about 5% of the first ones of the primary risk parameters within an agent group are assigned the first risk score.

9. A method as in claim 1, comprising applying a weighting criteria to each of the plurality of primary risk parameters, and wherein aggregating the primary parameter risk scores for each agent to define the agent risk score considers the weighting criteria.

10. A method as in claim 9 additionally comprising assigning a weight to each of the plurality of primary risk parameters via the agent risk analysis interface.

11. A method as in claim 1 additionally comprising aggregating data from the transactions database for the selected analysis time period to determine a secondary risk parameter result for each agent.

12. A method as in claim 11 additionally comprising for each agent comparing the secondary risk parameter result to a criteria saved on a system to determine whether the secondary risk parameter meets a risk criteria, and modifying the agent risk score if the secondary risk parameter meets the risk criteria.

13. A method as in claim 12 additionally comprising calculating a second parameter calculation value using data from the transactions database independently from the outlier agent identification analysis and maintaining the second parameter calculation value on the system, and wherein calculating a second one of the plurality of primary risk parameters comprises retrieving the second parameter calculation.

14. A method as in claim 1, wherein the grouping criteria considers each agent's geographic location, and agents located within a first geographic region are in the first group and agents located within a second geographic region are in the second group.

15. A method for mitigating risks associated with agents of a money transfer organization in which a plurality of agents facilitate a high volume of money transfers from remitters to beneficiaries, comprising:
processing a high volume of money transfers in which each of the plurality of agents interacts with a plurality of remitters and/or a plurality of beneficiaries;
storing data concerning each of the money transfers in a transactions database;
performing an outlier agent identification analysis, comprising:
for each of the plurality of agents, aggregating data from the transactions database concerning a plurality of primary risk parameters for a selected analysis time period;
generating a primary risk statistical distribution for each primary risk parameter;
in consideration of the primary risk statistical distribution, assigning an agent risk score to each of the plurality of agents, the agent risk score being based on the extent to which the plurality of primary risk parameters for one of the plurality of agents are outliers relative to plurality of primary risk parameters of the rest of the plurality of agents;
generating an agent risk score statistical distribution of the agent risk scores of the plurality of agents, and identifying outlier agent risk scores as agent risk scores that meet or exceed a threshold outlier status relative to other agent risk scores in the agent risk score statistical distribution; and
identifying each of the plurality of agents that has an outlier agent risk score as an outlier agent and generating an agent alert for each outlier agent;
generating a report aggregating data from the transaction database concerning the outlier agent in each agent alert;
a human analyst reviewing the report associated with the agent alert and recording observations about the outlier agent;
saving data concerning each agent alert and analyst observations; and
taking action concerning each outlier agent based on the analyst observations.

16. A method as in claim 15, wherein taking action concerning a first one of the outlier agents comprises one or more of terminating the agent alert associated with the first one of the outlier agents, mandating a training regimen for the first one of the outlier agents, suspending the first one of the outlier agents, and terminating associating with the first one of the outlier agents, and saving a record of the action taken in the system.

17. A method for efficiently and effectively identifying suspicious use of a money transfer system, comprising:
processing a high volume of money transfer transactions, money transfer transactions comprising:
receiving a remitter data concerning a remitter, a beneficiary data concerning a beneficiary, and a transfer amount of money from a remote agent system; and
transferring the transfer amount of money to a paying agent, the transfer amount of money being earmarked for delivery to the beneficiary;
storing transaction data concerning each of the money transfer transactions in a transactions database, each transaction data comprising a plurality of data points, and comprising at least the following data points: the amount of money, the transaction date, the remitter data, the beneficiary data and an agent data;
storing a plurality of business rules on an analysis system, each of the business rules defining criteria for triggering an alert;
for each of the plurality of business rules, analyzing the transaction data from the transactions database and, if the transaction data associated with one or more of the money transfer transactions collectively meets the criteria for a first one of the business rules, generating an alert and saving the alert on the analysis system, the one or more money transfer transactions being one or more origin transactions for the alert;
for each alert, searching the transaction data from the transactions database to identify secondary transactions having one or more data points that are the same as one or more data points of the one or more origin transactions;
for each alert, generating a report identifying and presenting the origin transactions, the secondary transactions, and an identification of criteria matching secondary transactions to origin transactions;
for each alert, a human analyst accessing and reviewing the report and recording observations about the alert; and
saving data concerning each alert and analyst observations.

18. A method as in claim 17, wherein each money transfer transaction additionally comprises a real time financial screening, comprising accessing data from a database of the money transfer system and comparing one or more of the remitter data and beneficiary data, wherein the money transfer transaction may proceed only if the one or more of the remitter data and beneficiary data manages the data from the database.

19. A method as in claim 17, wherein each money transfer transaction additionally comprises a real time financial screening, comprising accessing transactions data concerning the remitter and/or beneficiary from the transactions database and accessing a screening criteria from a database of the money transfer system, aggregating amount data from the transactions data with the amount entered by the agent, and if the aggregated amount data exceeds the screening criteria generating a communication to the remote agent system.

20. A method as in claim 19, wherein the communication comprises one or more of a disapproval of the transaction or a request for more detailed identification information concerning one or more of the remitter and beneficiary.
